(19) United States
(12) Patent Application Publication
(10) Pub. No.: US 2024/0311819 A1
(43) Pub. Date: Sep. 19, 2024

(54) SYSTEM AND METHOD FOR CONNECTING, MANAGING OR TRANSFERRING NON-FUNGIBLE TOKENS

(71) Applicant: DMARKET INC., Wilmington, DE (US)

(72) Inventors: Volodymyr Panchenko, Kiev (UA); Andrii Svystovych, Kyiv (UA); Mykyta Bokovyi, Kharkiv (UA); Oleksandr Shavelev, Dnipro (UA); Mykhailo Yashchenko, Kyiv (UA); Oleksandr Romanov, Kyiv (UA); Mykhailo Kovetskyi, Kyiv (UA); Anton Trybulkevych, Mykolaiv (UA); Vladyslav Andrusenko, Kyiv (UA); Pavlo Yeremenko, Poltava (UA); Sergei Liubyi, Cherkasy (UA); Vitaliy Soultan, Kyiv (UA); Dmytro Shchedov, Union City, NJ (US)

(73) Assignee: DMARKET INC., Wilmington, DE (US)

(21) Appl. No.: 18/268,458

(22) PCT Filed: Dec. 21, 2021
(86) PCT No.: PCT/US2021/064706

§ 371 Date: Jun. 20, 2023

Related U.S. Application Data
(60) Provisional application No. 63/128,643, filed on Dec. 21, 2020.

(51) Int. Cl. G06Q 20/38

(52) U.S. Cl. CPC G06Q 20/389; G06Q 2220/18

(57) ABSTRACT

Systems and method for performing transfers non-fungible tokens (NFT). For instance, the system includes a first blockchain module of a first blockchain technology; a second blockchain module of a second blockchain technology; an integration module configured to store computer executable instructions for communicating with a plurality of blockchain technologies including the first and second blockchain technologies. The system withdraws the NFT from the first blockchain module; locks the NFT on the first blockchain module; deposits the NFT to the second blockchain module; unlocks the NFT on the second blockchain module; and records the transfer of the NFT on the first or second blockchain module.

### CROSS REFERENCE TO RELATED APPLICATIONS

This application claims priority to U.S. Provisional Patent Application Ser. No. 63/128,643, the entirety of which is incorporated herein in its entirety.

### BACKGROUND

The disclosure relates to implementing a so-called metaverse that allows many individual users to participate in a virtual environment, in which they can obtain, purchase, trade, sell, and otherwise dispose of many non-fungible tokens (NFTs) or other digital assets. Current implementations of metaverses typically allow only one blockchain to support transactions of NFTs and other digital assets, and fail to offer any methodology by which NFTs can be moved to different blockchains.

Blockchain technologies have been used to allow for recording of transaction information in a manner that offers security and transparency. Different blockchains or blockchain technologies are not interchangeable. Assets located on one blockchain cannot be readily moved to another blockchain due to the immutable nature of the transactions. The limitations of current blockchain algorithms and techniques creates barrier to adoption and have led to a proliferation of separate platforms that cannot be connected together, leading to separate islands in which non-interoperable digital assets are stranded. Therefore, improvements are needed in this field to advance the technology of digital asset management.

### BRIEF SUMMARY

For instance, disclosed herein are systems and methods for performing transfers, management, connection, or other functions on non-fungible tokens (NFT). In one embodiment, the system includes a first blockchain module of a first blockchain technology; a second blockchain module of a second blockchain technology; an integration module configured to store computer executable instructions for communicating with a plurality of blockchain technologies including the first and second blockchain technologies. The system withdraws the NFT from the first blockchain module; locks the NFT on the first blockchain module; deposits the NFT to the second blockchain module; unlocks the NFT on the second blockchain module; and records the transfer of the NFT on the first or second blockchain module.

One advantage of the disclosure relates to the integration of various NFT-supporting modules. That integration has the ability to transfer NFTs between modules while keeping information about the authenticity of the NFT. This information can be exposed publicly as part of the platform to build trust in the solution.

Advantageously, an integration module has knowledge about supported modules and how to interact with them to withdraw an NFT from it and deposit an NFT to it. As another advantage, transferring from one NFT-supporting module to another disables the ability to act on the NFT within the sourcing module and grants the ability to act within a pre-defined set of actions in the destination module.

As a further advantage, NFTs that are circulating in the disclosed solution can have or have no additional usage within the supported module. Thus, the NFT can either just represent itself or be a subject for extra logic like (but not limited to) having mapping to the module's internal objects, characters, visual representations, etc.

As an additional advantage, a bridges module, which is an application that has software deployed in each module or software that uses the module's API to deposit or withdraw an NFT, can store results in a different blockchain to show the history of transfer from the moment of NFT original minting till any other moment of time (limited by present time). Thus, information about the history of transfers can prove the authenticity of the NFT.

As an additional advantage, the disclosed system can serve multiple functions, including being the primary destination for the NFTs minting/originating NFTs, storing information of transfer between modules information into a blockchain, in addition to financial tokens into blockchain.

The above embodiments are exemplary only. Other embodiments as described herein are within the scope of the disclosed subject matter.

### BRIEF DESCRIPTION OF THE SEVERAL VIEWS OF THE DRAWINGS

So that the manner in which the features of the disclosure can be understood, a detailed description may be had by reference to certain embodiments, some of which are illustrated in the accompanying drawings. It is to be noted, however, that the drawings illustrate only certain embodiments and are therefore not to be considered limiting of its scope, for the scope of the disclosed subject matter encompasses other embodiments as well. The drawings are not necessarily to scale, emphasis generally being placed upon illustrating the features of certain embodiments. In the drawings, like numerals are used to indicate like parts throughout the various views, in which:

FIG. 1. illustrates an example metaverse schema, in accordance with one or more aspects set forth herein;

FIG. 2. illustrates the interaction of an integration module and a bridges module, in accordance with one or more aspects set forth herein;

FIG. 3. illustrates a withdrawal interface schema, in accordance with one or more aspects set forth herein;

FIG. 4. illustrates a deposit interface schema, in accordance with one or more aspects set forth herein;

FIG. 5. illustrates a transfer of an NFT from one blockchain to another blockchain, in accordance with one or more aspects set forth herein;

FIG. 6. illustrates a transfer of an NFT from one blockchain to another blockchain, in accordance with one or more aspects set forth herein;

FIGS. 7A-7I illustrate graphical user interfaces, in accordance with one or more aspects set forth herein;

FIGS. 8A-8B illustrate graphical user interfaces, in accordance with one or more aspects set forth herein;

FIGS. 9A-9O illustrate graphical user interfaces, in accordance with one or more aspects set forth herein;

FIGS. 10A-10Q illustrate graphical user interfaces, in accordance with one or more aspects set forth herein;

FIGS. 11A-11Z illustrate graphical user interfaces, in accordance with one or more aspects set forth herein; and

FIGS. 12A-12Z illustrate graphical user interfaces, in accordance with one or more aspects set forth herein.

Corresponding reference characters indicate corresponding parts throughout several views. The examples set out herein illustrate several embodiments, but should not be construed as limiting in scope in any manner.

### DETAILED DESCRIPTION

The present disclosure relates to digital asset management generally, and the integration of various blockchains and blockchain technologies specifically. In one aspect, the integration of various NFT-supporting modules provides the ability to transfer NFTs between modules (e.g., different blockchains) while keeping information about the authenticity of the NFT. This information can be exposed publicly as part of the platform to build trust in the solution. In such a way, the field of blockchain technology and NFT technology has been furthered by the present technique of allowing interoperability between different blockchains (sometimes referred to herein as blockchain modules or just modules). Advantageously, the present disclosure allows for different private entities to create and manage private blockchains, while at the same time allowing for specific integration points, which allow technological integration, between the private blockchains, or other public blockchains. In order to achieve this, at a high level, techniques are disclosed herein for allowing the withdrawal of an NFT from one blockchain and an addition of the NFT into a different blockchain without losing the ability to secure ownership and provide relative transparency of the transaction.

In one embodiment, an integration module includes technical details and knowledge about a plurality of supported blockchain modules and how to interact with them to withdraw an NFT from one and deposit an NFT to another. Since each separate blockchain module (i.e., different private or public blockchains) will have different methodologies for achieving this, the integration module of the present disclosure maintains state data of all the different supported blockchain modules that allow for execution of withdrawal of an NFT on a first blockchain and deposit of an NFT on a second blockchain. In such a case, e.g., when transferring from one NFT-supporting module to another, the integration module disables the ability to act on the NFT within the sourcing blockchain module and grants the ability to act within a pre-defined set of actions in the destination blockchain module. This ensures that the NFT has been successfully transferred.

NFTs that are circulating in the disclosed solution can have or have no additional usage within the supported module. For instance, the NFT can either just represent itself or be a subject for extra logic like (but not limited to) having mapping to the module's internal objects, characters, visual representations, smart contracts, executable code, etc.

In one embodiment, the bridges module is an application that has software deployed in each module or software that uses the module's API to deposit or withdraw NFTs from multiple different blockchain modules. Results of the transfer of NFT from Module A to Module B are stored in a specific blockchain, here labeled as a DMarket blockchain (but this label is arbitrary, and the blockchain can be owned by any entity), to show the history of transfer from the moment of NFT original minting until any other moment of time (limited by present time). The term DMarket blockchain will be used interchangeably with market blockchain, where the market blockchain can have all the features of any other blockchain but can also be used to store information about the transfers of the NFT. Information about the history of transfers on this DMarket (or market) blockchain can then prove the authenticity of the NFT and the transfer thereof.

In one embodiment, the DMarket (or market) blockchain module serves multiple functions. The market blockchain is the primary destination for the NFTs minting if the NFTs are originated within the ecosystem of that specific market blockchain (e.g., the DMarket blockchain) in which case it behaves like any other blockchain. For example, the bridges module stores transfer between modules information into the market blockchain. Further, a marketplace module can store financial tokens into the market blockchain.

As noted above, the so-called DMarket blockchain is one example of a market blockchain, which includes its own solutions (e.g., minting of specific NFTs) but also facilitates transfer of NFTs among multiple other blockchains or blockchain modules, by acting as a market blockchain to store transfer information.

In one example, the DMarket blockchain allows viewers of any online streaming platforms or VOD (Video on Demand Service) to actively interact and participate in live entertainment activity during live streams on such platforms and services. This solution provides that such interaction and participation is happening simultaneously in live streams on such platforms/service and on a mobile device of such user with the help of mobile application. Advantageously, this solution allows viewers to receive digital items or their parts referred to as drops. In this example, the user who receives digital items is decided by an automated mechanism based on specific developed methods and algorithms. In this example, digital items include various software products, including from e-games that exist in digital form represented by respective software program codes, designs, skins, promo-codes, product or service, and cosmetics or other items, being objects of intellectual property, and/or that are designated to be utilized in e-games, during live streams on online streaming platforms or VOD, etc. This example allows viewers (users) to collect, trade, exchange, piece together/integrate/craft digital items/their parts in new digital items, intangible assets, services. Such digital items, intangible assets, services or their parts can be used in e-games or be part of e-game's digital items, simultaneously represent material things (tangible assets), including but not limited digital redeemable code to exchange digital item for material things (tangible assets), and can be created/used via blockchain. This allows various companies and brands to interact with their consumers in innovative way.

One example is an interactive field (space) online multiplayer in the window of any streaming platform or service, facilitating interaction with the stream. In such a case, viewers can see what is happening on the screen or/and vote, and/or see who received digital items, what digital items are dropping next, etc. Viewers can also influence the stream: they receive some digital items (decided by automated mechanism working based on developed methods and algorithms of work) with which they can craft a whole other digital item. If they miss other parts/digital items, they can buy or exchange them on the market blockchain. For example, if a whole digital item is crafted it is shown in the stream. During the stream the users see instructions (“recipes”) of how to craft a new whole digital item from pieces, what instructions are available to them or anybody in the web application and what whole digital item they can craft with digital items in their inventory.

Generally stated, provided herein, in one aspect is a system for performing a transfer of a non-fungible token (NFT) from a first blockchain to a second blockchain. For instance, the system comprises a first blockchain module of a first blockchain technology; a second blockchain module of a second blockchain technology; an integration module, the integration module configured to store computer executable instructions for communicating with a plurality of blockchain technologies including the first and second blockchain technologies. The system is configured for: withdrawing the NFT from the first blockchain module; locking the NFT on the first blockchain module; depositing the NFT to the second blockchain module; unlocking the NFT on the second blockchain module; and recording the transfer of the NFT on the first or second blockchain module.

In one embodiment, the system further comprises a bridge module, the bridge module configured to communicate with the integration module to receive instructions and communicate with the first and second blockchain modules to send instructions. In another embodiment, the first blockchain module is part of a video game system and the second blockchain module is a public blockchain that is not part of a video game system. In a further embodiment, the system includes a content provider comprising the first blockchain module, the content provider providing content to a customer, wherein the customer interacts with the content provider to mint the NFT.

In one implementation, the NFT represents a digital asset on the first blockchain module, and represents a physical asset on the second blockchain module, wherein the transfer of the NFT results in a delivery of the physical asset to a customer.

In another aspect, presented herein is a system for performing a transfer of a non-fungible token (NFT) from a first blockchain to a second blockchain. The system includes a first blockchain module of a first blockchain technology, the first blockchain module comprising a private blockchain; a second blockchain module of a second blockchain technology, the second blockchain comprising a public blockchain; a third blockchain module of a third blockchain technology; an integration module, the integration module configured to store computer executable instructions for communicating with a plurality of blockchain technologies including the first and second blockchain technologies; bridge module configured to communicate with the integration module to receive instructions and communicate with the first and second blockchain modules to send instructions. The system is configured for: withdrawing the NFT from the first blockchain module; locking the NFT on the first blockchain module; depositing the NFT to the second blockchain module; unlocking the NFT on the second blockchain module; and recording the transfer of the NFT on the third blockchain module.

In such a case, in one example, the system includes a content provider comprising the first blockchain module, the content provider providing content to a customer. Thus, the customer interacts with the content provider to mint the NFT. In another example, the NFT represents a digital asset on the first blockchain module, and represents a physical asset on the second blockchain module, wherein the transfer of the NFT results in a delivery of the physical asset to a customer. In a further example, the NFT represents a digital asset on the first blockchain module, and represents a physical asset on the second blockchain module, wherein the transfer of the NFT results in a delivery of the physical asset to a customer.

In another aspect, presented herein is a method for performing a transfer of a non-fungible token (NFT) from a first blockchain to a second blockchain. The method comprises providing a first blockchain module of a first blockchain technology; providing a second blockchain module of a second blockchain technology; storing computer executable instructions for communicating with a plurality of blockchain technologies including the first and second blockchain technologies; withdrawing the NFT from the first blockchain module; locking the NFT on the first blockchain module; depositing the NFT to the second blockchain module; unlocking the NFT on the second blockchain module; and recording the transfer of the NFT on the first or second blockchain module. In such a case, in one example, the method further includes communicating to receive instructions from the first and second blockchain modules to send instructions. In another example, the first blockchain module is part of a video game system and the second blockchain module is a public blockchain that is not part of a video game system. In a further example, the method further includes providing content to a customer, wherein the customer interacts with the content to mint the NFT. In another example, the NFT represents a digital asset on the first blockchain module, and represents a physical asset on the second blockchain module, wherein the transfer of the NFT results in a delivery of the physical asset to a customer.

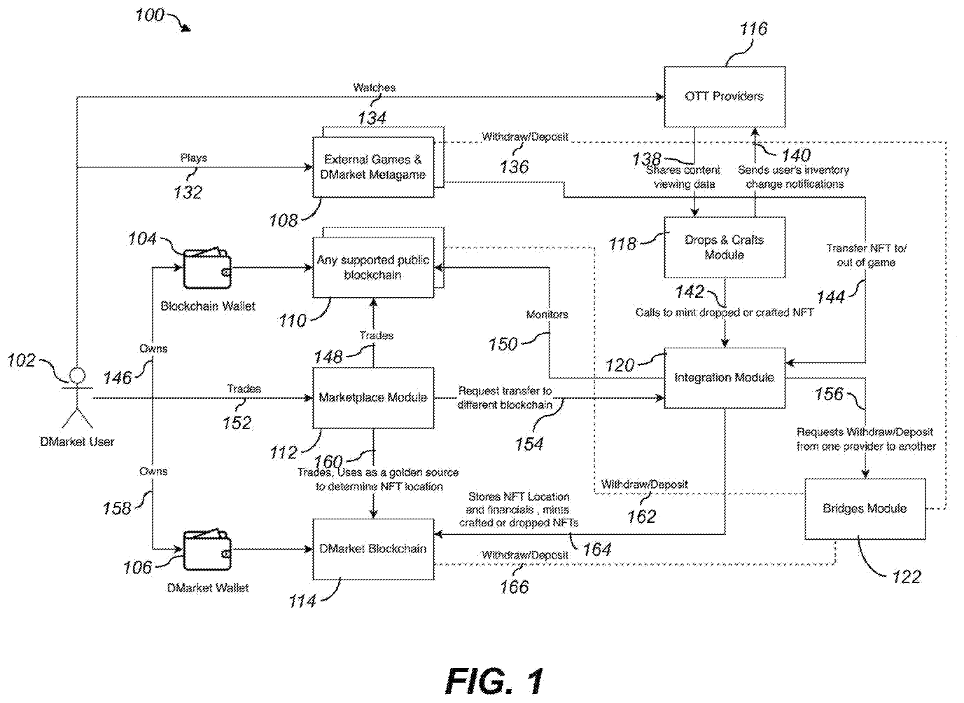

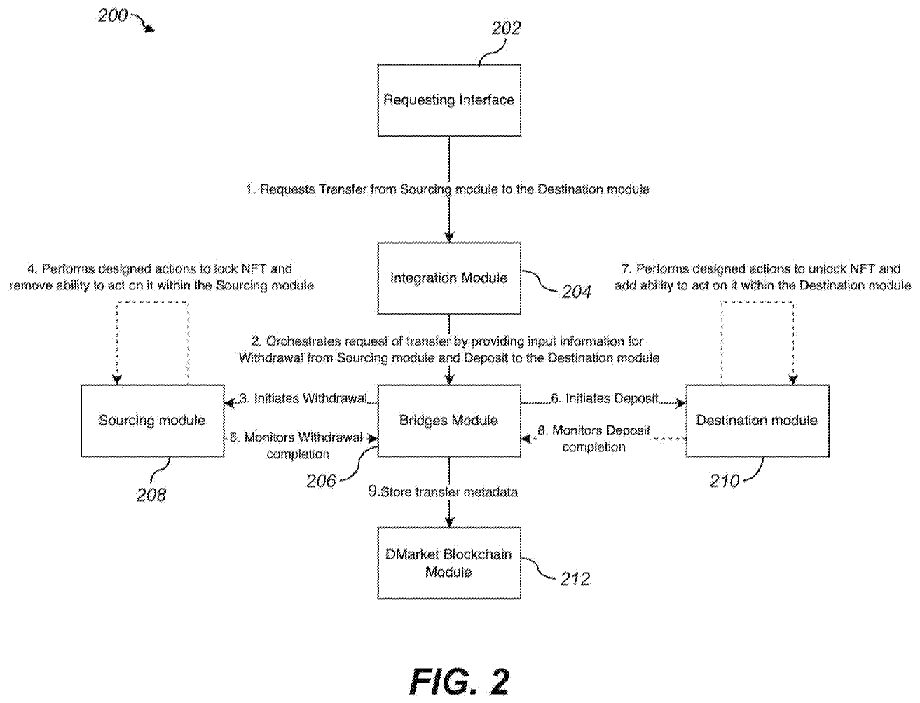

FIG. 1. illustrates a detailed working example of a metaverse schema 100 that illustrates an example of how a market blockchain user could be involved in a metaverse. The discussion below with respect to FIGS. 2-6 will explain how these elements interact together. In the example of FIG. 1, a user 102 owns a DMarket (i.e., market) blockchain wallet 106 and an external blockchain wallet 104. Schema 100 supports NFT trading and exchange on a marketplace, depositing/withdrawing NFTs from supported external/internal games, and over-the-top (OTT) content watching.

The embodiment of FIG. 1 includes the following modules: a marketplace module 148, which is a main interface for trading and exchanges, and an bridges module 122; a Drops & Crafts module 118, which allows gamification with OTT providers and streams, receiving of NFT items during content watching and crafting NFT items into the higher value NFT tokens such as so-called “orbs;” a DMarket Metagame 108, which includes a game that uses player/DMarket user inventory NFTs as in-game inventory with mechanics of crafting, breeding, and obtaining new NFTs; Blockchain bridges. Set of Smart Contracts and supporting code that allows transfer NFTs between supported blockchains and DMarket proprietary blockchain 114 in any direction. The custodial solution that transfers NFTs, tracks their authenticity and exposes tracking and validation results to the public.

In addition, in one example, a DMarket Blockchain 114 could be a proprietary blockchain (based on a product available from Exonum or an EMV-compliant blockchain). Specifically, the DMarket blockchain 114 includes storage of NFTs, state of the transfers between blockchains and customer's coin balances. In one example, a DMarket wallet 106 may be a proprietary crypto wallet app that connects to the customer wallet inside of DMarket blockchain 114. For example, customers can start interaction with DMarket metaverse 100 after proper registration and logging in from any of DMarket web applications including (but not limited to): Marketplace 112, Drops & Crafts module 18, either on DMarket website or through OTT provider interfaces, Partner's Games and DMarket Metagame 108, or DMarket wallet 106.

FIG. 2. illustrates the interaction of an integration module 204 and a bridges module 206, for example, within the metaverse 100 discussed with respect to FIG. 1. Generally depicted in FIG. 2, integration module 204 and bridges module 206 interact with sourcing module 208 and destination module 210 to achieve NFT transfer.

In one embodiment, transfer transactions consist of two stages-withdrawal from the sourcing module 208 and transfer to the destination module 210.

As depicted in FIG. 2, an exemplary sequence of steps after initiating transfer is the as follows:
1. User request NFT transfer from Sourcing module 208 to Destination module 210 using Requesting Interface 202. Requesting interface 202 calls Integration Module 204 with data that contains NFT details, Source module details, and Destination module details.
2. Integration module 204 orchestrates request's data to the Bridges module 206 while enriching data with modules specifics like their type or the way how monitor response from each module.
3. Bridges module 206 uses the Withdrawal mechanism provided by the Sourcing module 208 to initiate withdrawal in the Sourcing module 208. Advantageously, various withdrawal mechanisms of different blockchain technologies are stored within the bridges module 206 to allow for interaction with different blockchain types, rather than being limited to a single blockchain technology.
4. The sourcing module 208 Locks the NFT state by its internal mechanisms.
5. The monitoring interface of the Sourcing module 208 is used to receive information about the NFT is Locked in Sourcing module 208.
6. The bridges module 206 uses the Deposit mechanism provided by the Destination module 210 to initiate a deposit in the Destination module 210.
7. The destination module 210 Unlocks the NFT state by its internal mechanisms.
8. The monitoring interface of the Destination module 210 is used to receive information about the NFT is Unlocked in the Destination module 210.
9. Transfer metadata is stored in the DMarket blockchain 212 to unequivocally identify the location of the NFT. Requesting interface 202 is notified that the transfer is completed.

Advantageously, the technique of FIG. 2 extends the capabilities of current solutions by bridging different blockchain modules (e.g., modules 208, 210) that are otherwise incompatible by using a combination of an integration module 204 and bridges module 206 to create an immutable trail of the transfer on market blockchain module 212. By contrast with conventional solutions, the present disclosure recognizes that it is not desirable to decentralize everything by having a single blockchain. Indeed, the present technique goes against the conventional wisdom by introducing a centralized market blockchain module 212 for showing the transfer of NFTs from one blockchain to another. This technique is made possible by the technological implementation of the integration module 204 and the bridges module 206 that allow storage of a plurality of routines specific to different blockchains for withdrawing and depositing NFTs to each specific blockchain, but at the same time locking and unlocking features. This represents a technological improvement to the computer systems themselves and the technology of NFT and blockchains.

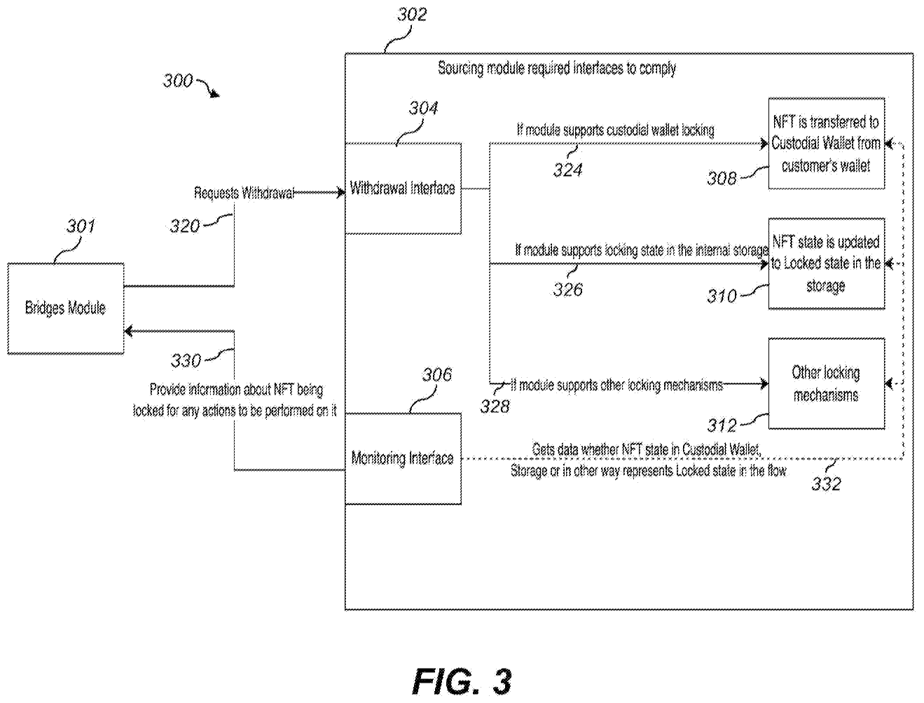

FIG. 3. illustrates a withdrawal interface schema 300. In the embodiment of FIG. 3, details of supporting Withdrawal are provided. For example, Supporting of Withdraw makes module compliant to integration with Bridges module 301 (e.g., bridges module 206 of FIG. 2).

In order to support this, block 302 includes a number of interfaces and features, including a withdrawal interface 304, which includes a mechanism that after the proper call of Withdraw interface 304 locks the state of NFT within the Module (e.g., sourcing module 208) for the one that prevents any actions on the NFT but Deposit from the Bridges module 301. That allows the Bridges module 301 to unequivocally transfer NFT out of the Module 206 and to module 208, for example.

In one embodiment, the bridges module 301 follows logic 320 to request withdrawal from the withdrawal interface 204. Next, the withdrawal interface 304 includes logic 324 to evaluate if the module supports custodial wallet locking. In such a case, at block 308, the NFT is transferred to a custodial wallet from the customers wallet. If at logic 326 the module supports locking state in the internal storage, then at block 310 the NFT state is updated to locked state in the storage. If at logic 328 the module supports other locking mechanisms, then at block 312 these other locking mechanisms are invoked. The foregoing is replicated for numerous different possible modules, such that the bridges module 301 is able to invoke the correct logic for each type of module. Next, logic 332 gets data of whether the NFT state is now locked based on each of the different possibilities discussed above, and the monitoring interface 306 at logic 330 provides information about NFT being locked for any actions to the bridges module 301.

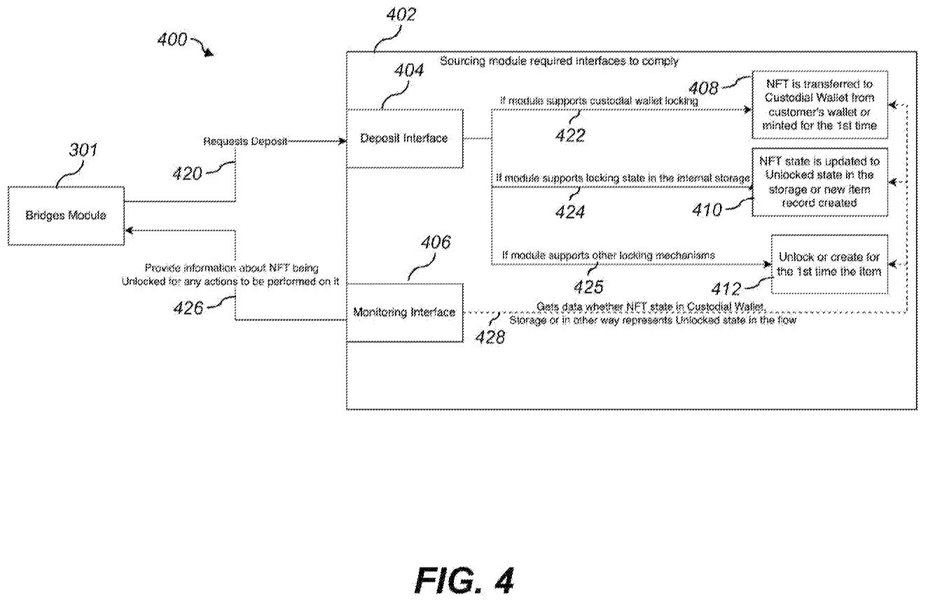

FIG. 4. illustrates a deposit interface schema 400. The embodiment of FIG. 4, illustrates how modules should implement their internal logic to support Deposit. Supporting of Deposit makes module compliant to integration with Bridges module 301. Requirements for the module to support Deposit include: Implement and expose the Deposit interface; Implement and expose the Monitoring interface; Have a mechanism that after the proper call of Deposit interface unlocks the state of NFT within the Module for the one that allows any actions within the Module. Or in case if the NFT has never been in the Module-mints it for the first time. That allows the Bridges module to unequivocally transfer NFT to the Module.

For example, in one embodiment, the bridges module 301 at logic 420 requests deposit via deposit interface 404. The deposit interface 404 at logic 422 determines if the module (to which the NFT is being deposited) supports custodial wallet locking. In such a case, at block 408 the NFT is transferred to a custodial wallet from the customer's wallet or minted for the first time. The deposit interface 404 at logic 424 determines if the module supports the locking state in internal storage. In such a case, at block 410, the NFT state is updated to the unlocked state in the storage or a new item record is created. The deposit interface 404 at logic 425 determines if the module supports other locking mechanisms, and responsive thereto at block 412 the other locking mechanisms are used to lock or create the NFT. The foregoing is replicated for numerous different possible modules, such that the bridges module 301 is able to invoke the correct logic for each type of module. Next, logic 428 gets the data of the NFT state and passes the data to monitoring interface 405, which at logic 426 provides information about the NFT being unlocked to the bridges module 301.

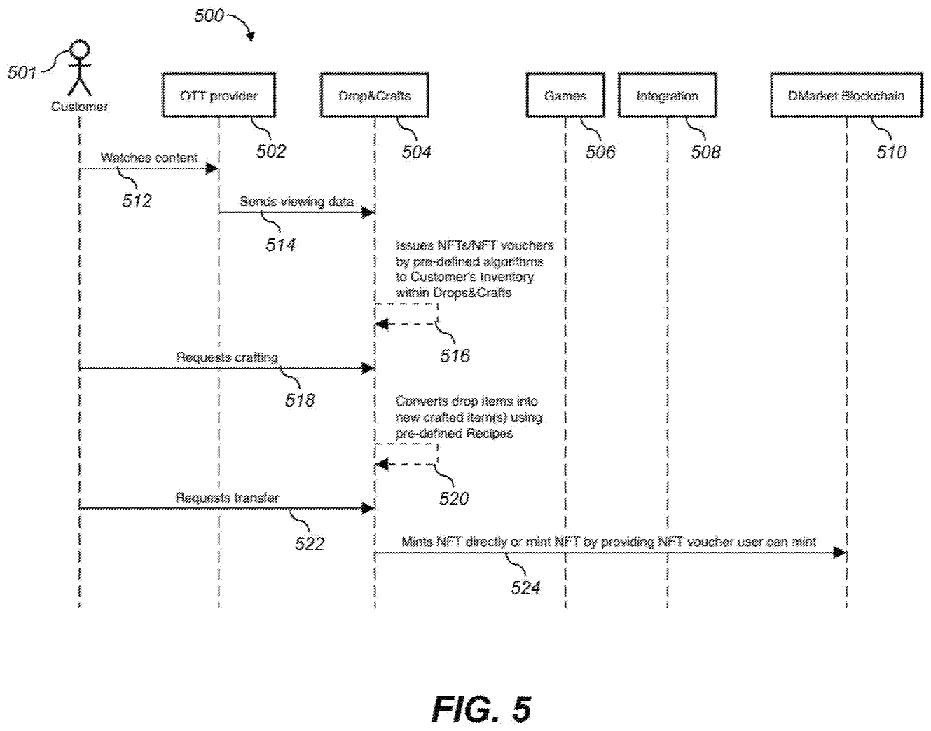

FIG. 5 illustrates method 500 that includes a transfer of an NFT from one blockchain 504 to another blockchain 510. In the embodiment of FIG. 5, a possible scenario is illustrated wherein the customer or user 501 receives Drop object in Drops & Crafts blockchain or module 504. The customer 501 at logic 512 watches content of an OTT provider 502, and at logic 514 sends viewing data to module 504. Later when the customer 501 has enough drops objects to craft them into the Craft using a pre-defined Recipe at logic 520 he crafts a Craft NFT at logic 518. Craft NFT is originated in Drops & Crafts blockchain or module 504 and available for transfer. The user initiates transfer to DMarket or market blockchain 510 at logic 522 and through the Integration module 508, NFT is first minted at logic 524 into DMarket blockchain 510. The NFT available for trade inside DMarket Marketplace and for transfer to any supported destination module like (but not limited to) External blockchain or DMarket Metagame, as discussed above with respect to FIGS. 1-4.

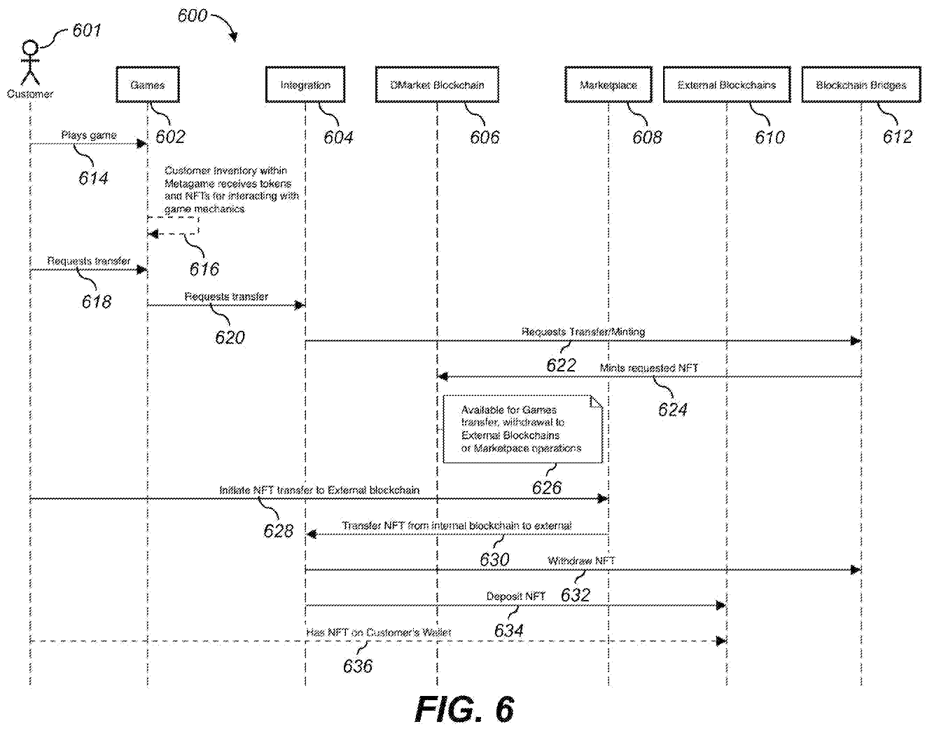

FIG. 6. illustrates a transfer of an NFT from DMarket or market blockchain or module 606 to another blockchain, such as external blockchain or module 610. In the embodiment of FIG. 6, a possible scenario is depicted in which a customer 601 obtains a certain object in the supported Game and desires to transfer it to the customer's Wallet inside the external blockchain. For instance, the customer 601 at logic 614 plays games at games module 602. Next, the customer at logic 616 receives tokens and NFTs while interacting with the games. Next, at logic 618 the customer 601 requests transfer of the NFTs at the games module 602. Next, the games module at logic 620 requests a transfer at the integration module 604. Next, the integration module 604 at logic 622 requests transfer and minting of the NFT by the blockchain bridges modules 612. Next, the blockchain bridges module 612 at logic 624 mints the requested NFT and it is stored on the DMarket or market blockchain 606, and is available to the customer to use in the game, transfer or withdraw, or use in marketplace operations. Next, the customer 601 at logic 628 initiates a transfer of the previously minted NFT from the DMarket blockchain module at the marketplace module 608, which is transferred at logic 630. Then, at logic 632, the NFT is withdrawn from the DMarket blockchain 606 by the blockchain bridges module 612. Next, at logic 634 the NFT is deposited at an external blockchain 610, and logic 636 the NFT resides in the customer's wallet at the external blockchain 610. Thus, the customer initiates a transfer of the object as NFT from the game inventory to the blockchain wallet of the choice. The integration module withdraws NFT from the game and deposits it into an external blockchain module while storing operation meta into the DMarket blockchain.

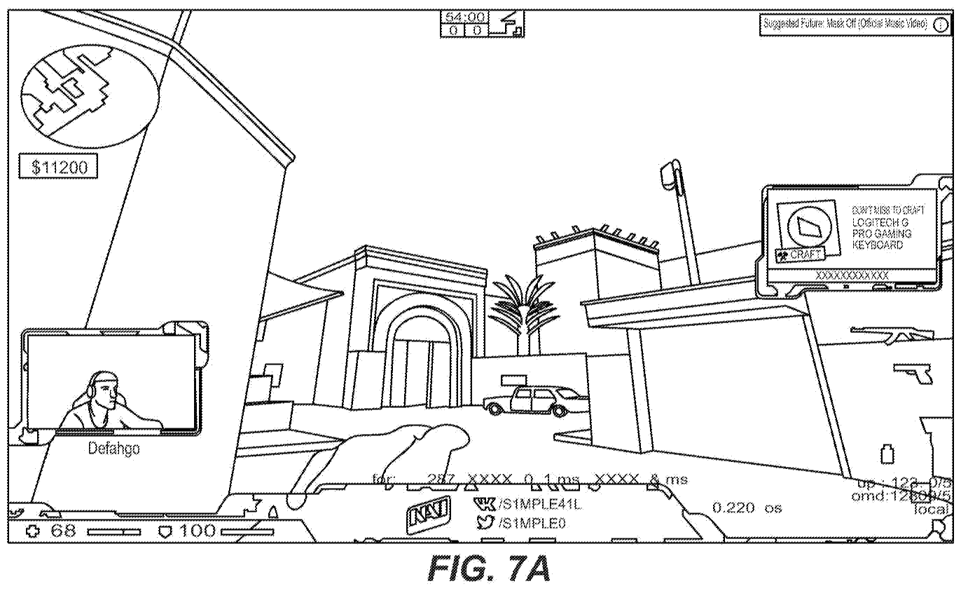

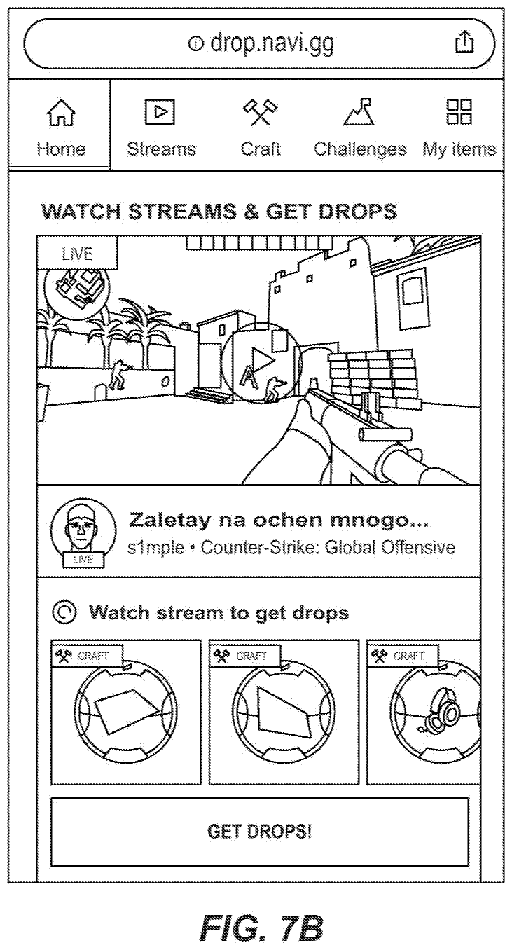

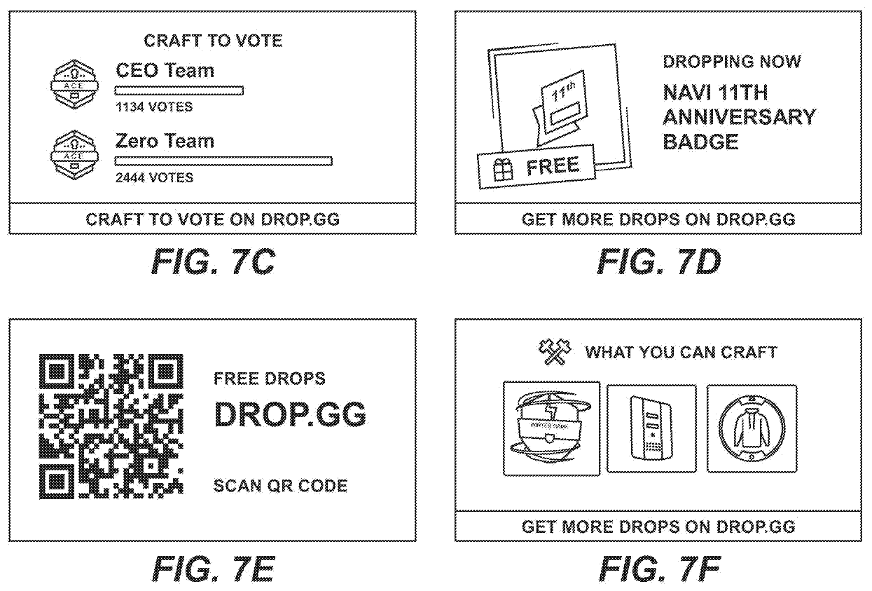

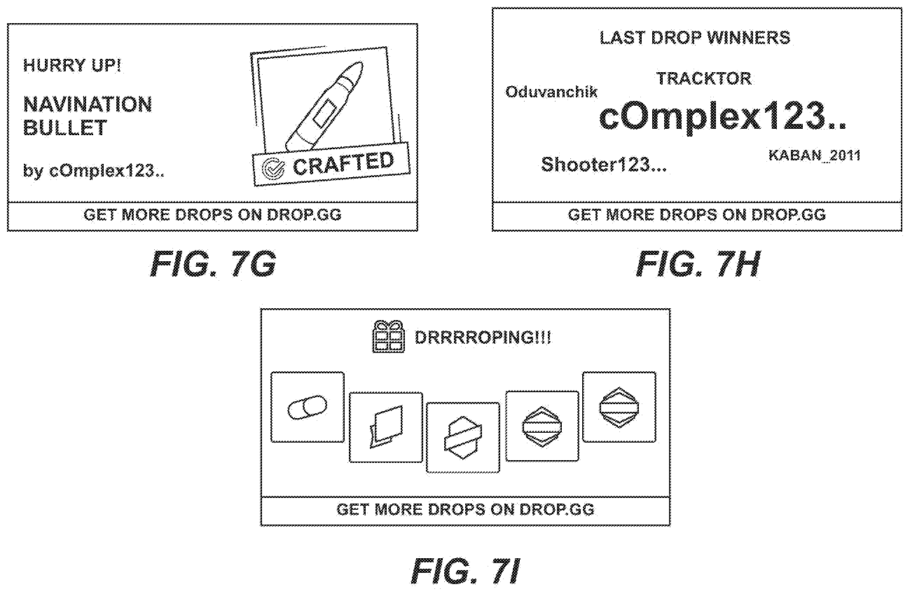

Turning next to exemplary graphical user interfaces, FIGS. 7A-12Z depict graphical user interfaces for implementing one or more embodiments set forth within FIGS. 1-6.

FIGS. 7A-7I illustrate graphical user interfaces. For instance, FIG. 7A depicts an example of a live stream with an OBS widget on the right side in the middle of the screen. In one embodiment, FIG. 7B depicts an example of a mobile application live stream.

In one or more embodiments, FIG. 7C depicts an example of information displayed in widget, about voting options. For example, during stream viewers have a chance to receive digital items that are pieces of badges. If the viewer collects (either receiving by drops, exchanging from other users or buying) all parts of the badge, he can craft it in his web application into such badge and in such a way vote for one of the teams.

In one or more embodiments, FIG. 7D depicts an example of information displayed in widget during a stream showing what viewers will receive (i.e., what is dropping).

In one or more embodiments, FIGS. 7E-7I depict examples of information displayed in widget during a stream: viewers can scan QR code and be redirected to stream on the web, i.e., informing that other viewers already crafted something.

By way of the examples of FIGS. 7A-7I, a user can see on a viewer what stream is live now, what digital items are dropping, what instructions/recipes are available and other information about the stream. Within this solution, the system creates certain digital items. They can be added/integrated/appear in different platforms, games. Users of video games can play with them in the games or wear them. The system also drops digital items that represent or with which you can craft new digital items that will represent/show material things (tangible assets). It can also be a redeemable code. For example, computer mouse: user can use this mouse in the game as a digital item or redeem it or a code that it represents for material things (tangible assets)—real mouse. Such digital items can be created/used via blockchain or not. If viewers don't have a certain digital item they need to have or need in order to craft other whole digital item, they can buy or exchange them directly on dmarket.com. They can sell digital items they have or trade digital items using all available functionality described above with respect to FIGS. 1-6.

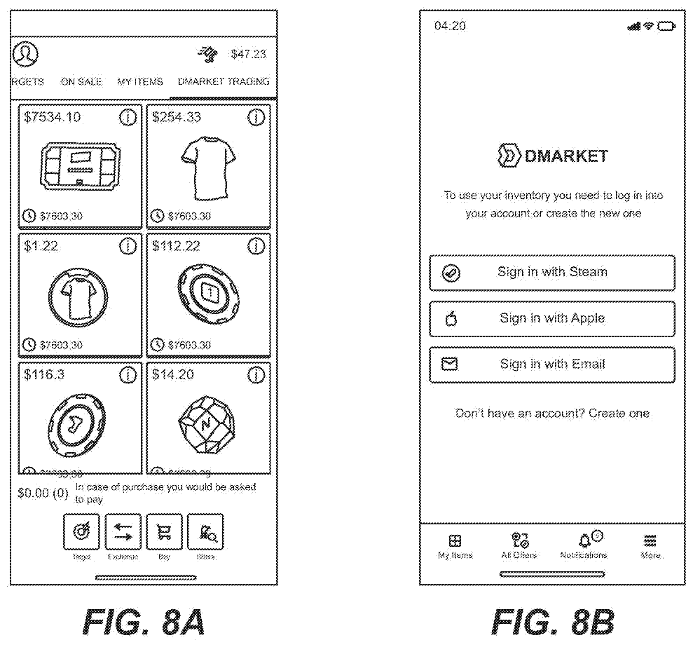

FIGS. 8A-8B illustrate graphical user interfaces of a mobile application system in accordance with FIGS. 1-6.

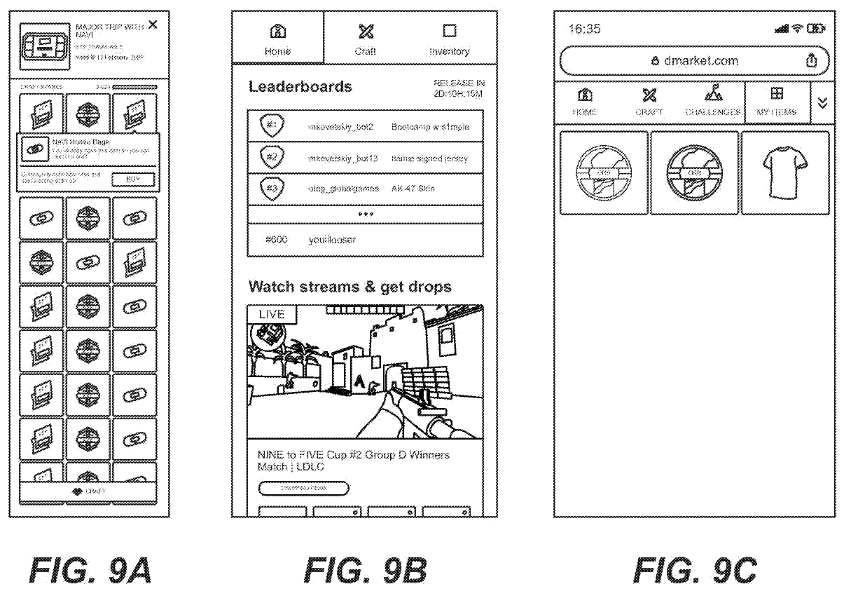

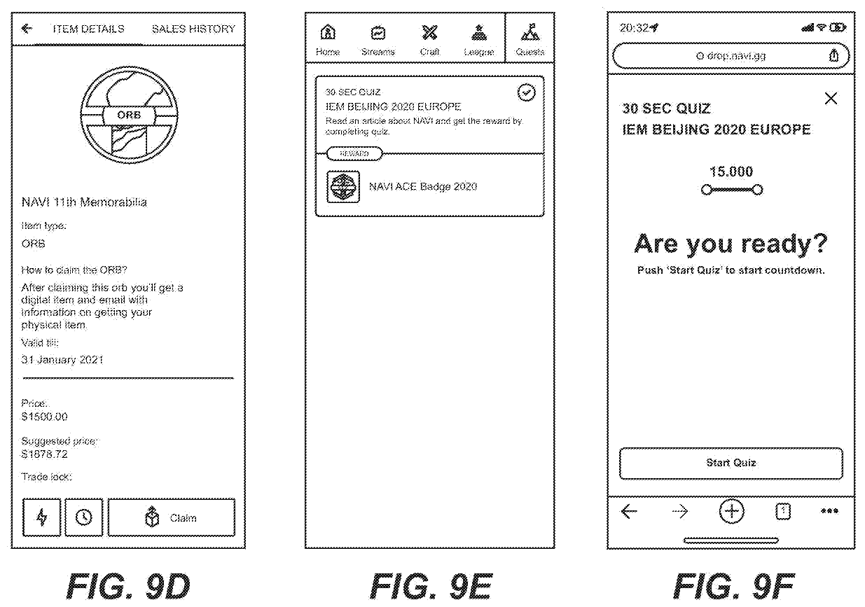

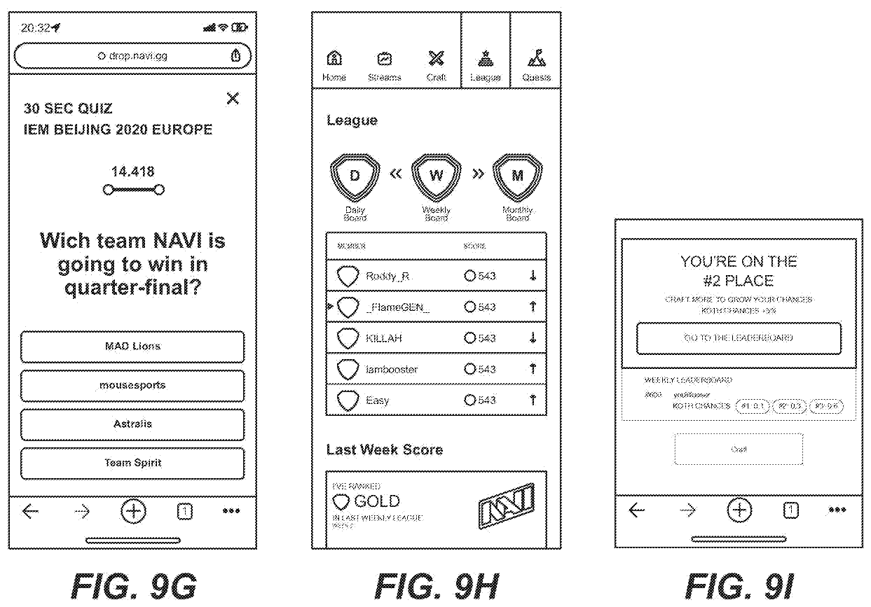

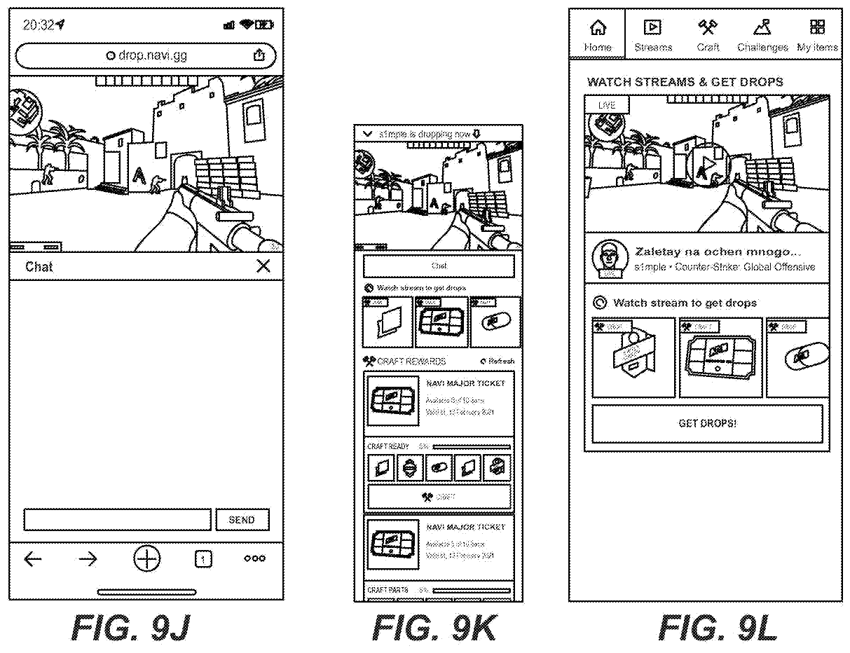

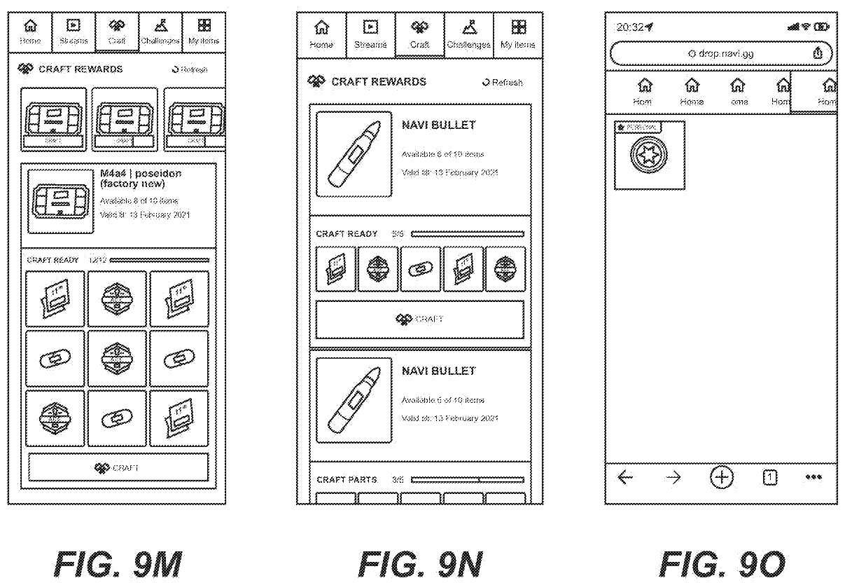

FIGS. 9A-9O illustrate graphical user interfaces. In one or more embodiments, FIG. 9A depicts an example of a general view in which whole digital item can be exchanged for a trip, a list of digital items that needs to be united to create this item, and a recipe for the same.

In one or more embodiments, FIG. 9B depicts an example of Leader board information.

In one or more embodiments, FIG. 9C depicts an example of inventory (“My items”) of Viewer.

In one or more embodiments, FIG. 9D depicts an example of items from inventory with more detailed information

In one or more embodiments, FIG. 9E depicts an example of Quests that a customer can try to pass, and if successful, can revive digital item (the one shown).

In one or more embodiments, FIG. 9F-9G depict example of quizzes

In one or more embodiments, FIG. 9H depicts examples of a “League”. A user can switch the league, choose them, have scores there etc.

In one or more embodiments, FIG. 9I depicts examples where users craft digital items from one they have, they also see their score.

In one or more embodiments, FIG. 9J depicts examples of chat.

In one or more embodiments, FIG. 9K depicts examples of a view when certain streamer is streaming, playing live. This is example with e-sport player simple streaming (playing). When he is streaming—certain digital items are dropping (depicted), there is instruction what you can craft with them and challenges available.

In one or more embodiments, FIG. 9L depicts examples of stream and what option viewers have.

In one or more embodiments, FIGS. 9M-9N depict examples of crafting section: recipe, inventory, status of users' crafting.

In one or more embodiments, FIG. 90 depicts example of user's digital item in inventory.

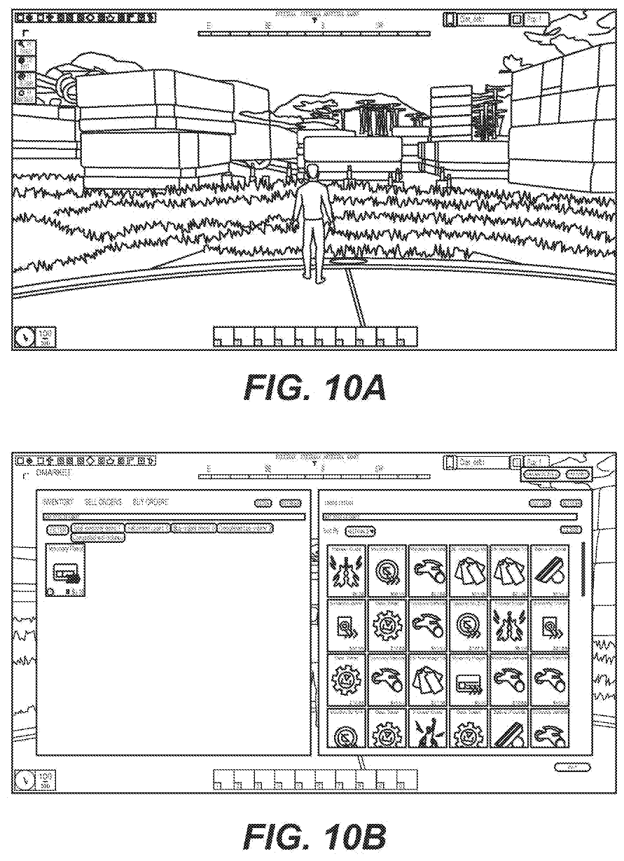

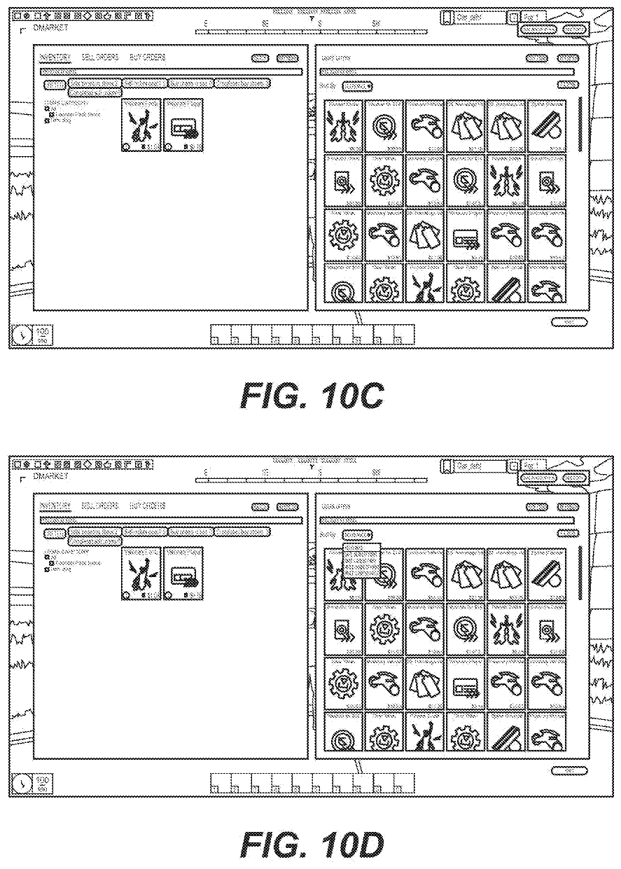

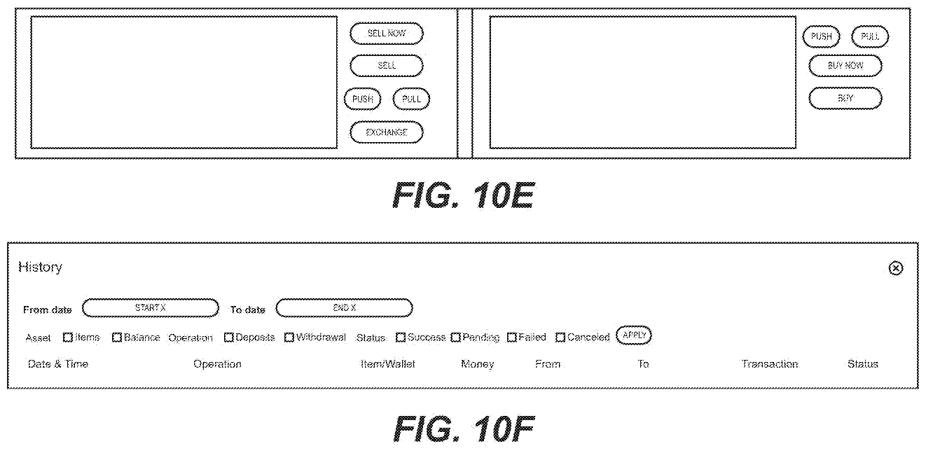

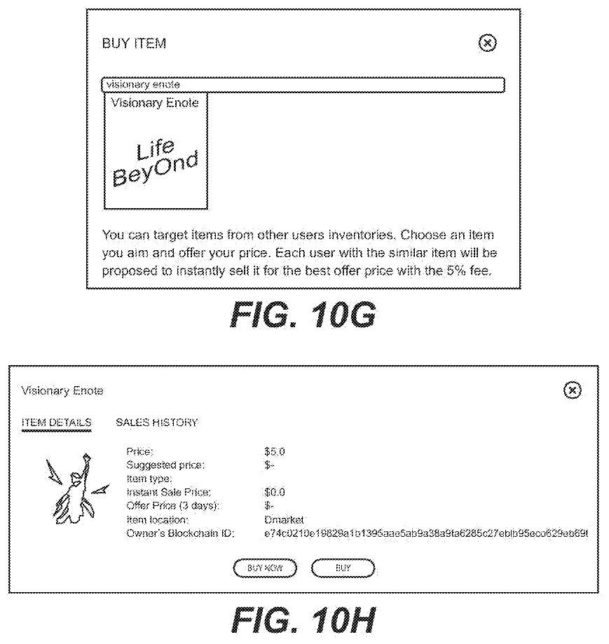

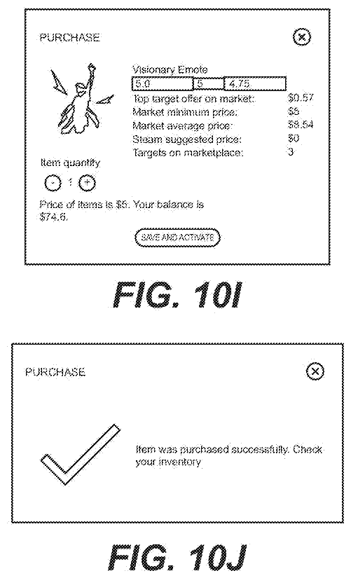

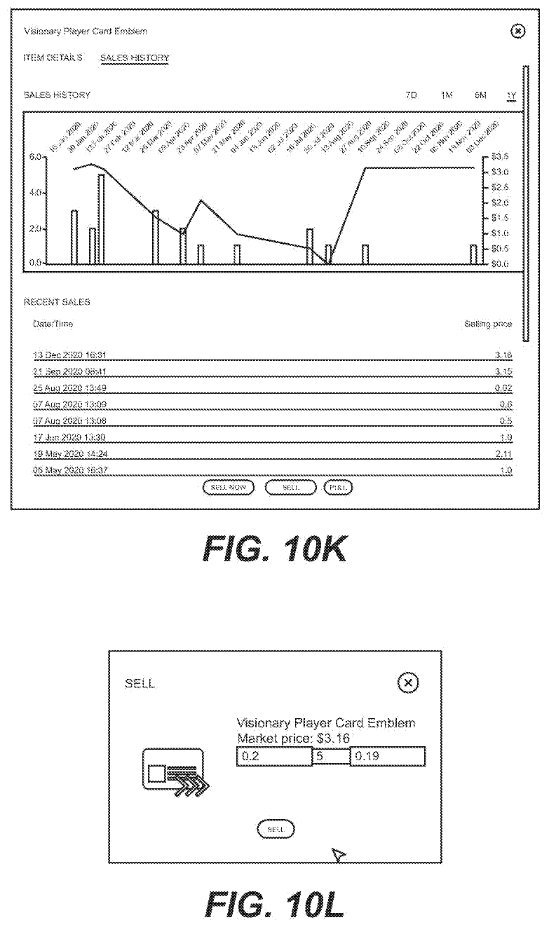

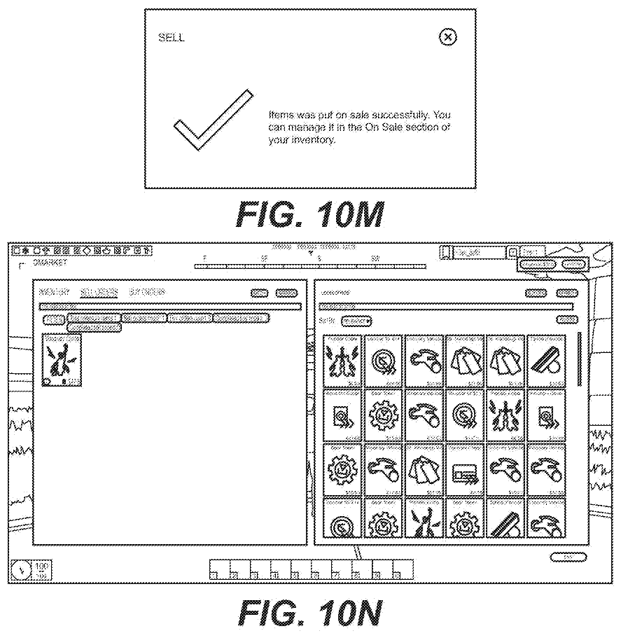

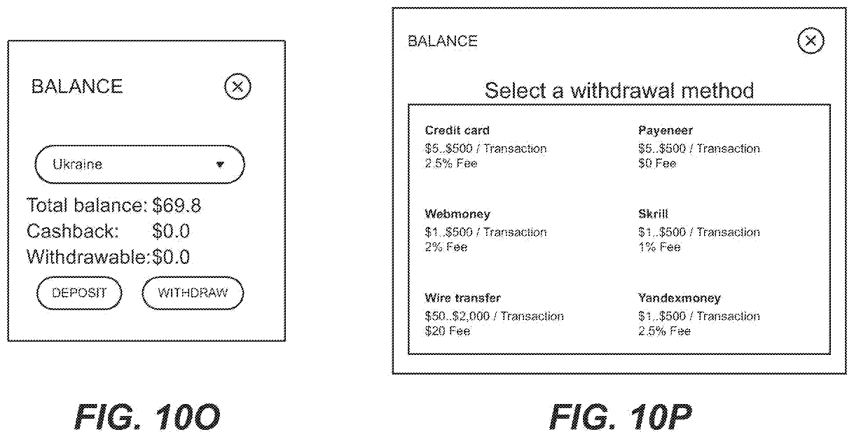

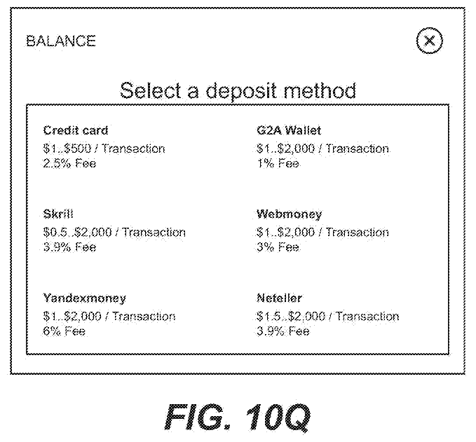

FIGS. 10A-10Q illustrate graphical user interfaces. In one or more embodiments, FIG. 10A depicts an example of videogame where the solution of FIGS. 1-6 will be integrated.

In one or more embodiments, FIGS. 10B-10C depict an interface of a game solution provide for users (players) access to their inventory.

In one or more embodiments, FIG. 10D depicts sorting options.

In one or more embodiments, FIG. 10E depicts an example of how users put digital items on sale form their inventory.

In one or more embodiments, FIG. 10F depicts an example of a history of users' inventory

In one or more embodiments, FIG. 10G-10J depicts how users look for item to buy and target them.

In one or more embodiments, FIG. 10K depicts Sales history users can see on the screens.

In one or more embodiments, FIG. 10L-10M depict how users sell items.

In one or more embodiments, FIG. 10N depicts how sell orders are shown.

In one or more embodiments, FIG. 10O depicts a users' balance.

In one or more embodiments, FIG. 10P depicts how users withdraw funds.

In one or more embodiments, FIG. 10Q depicts how users deposit funds.

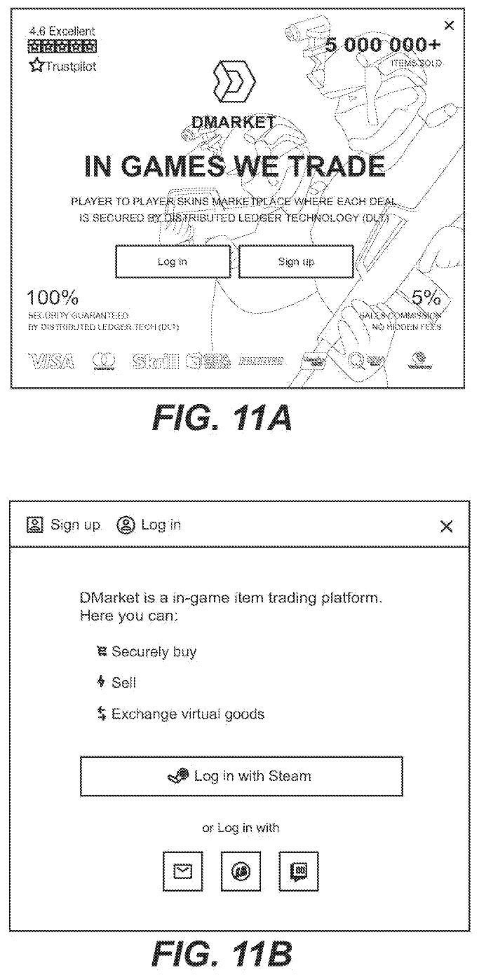

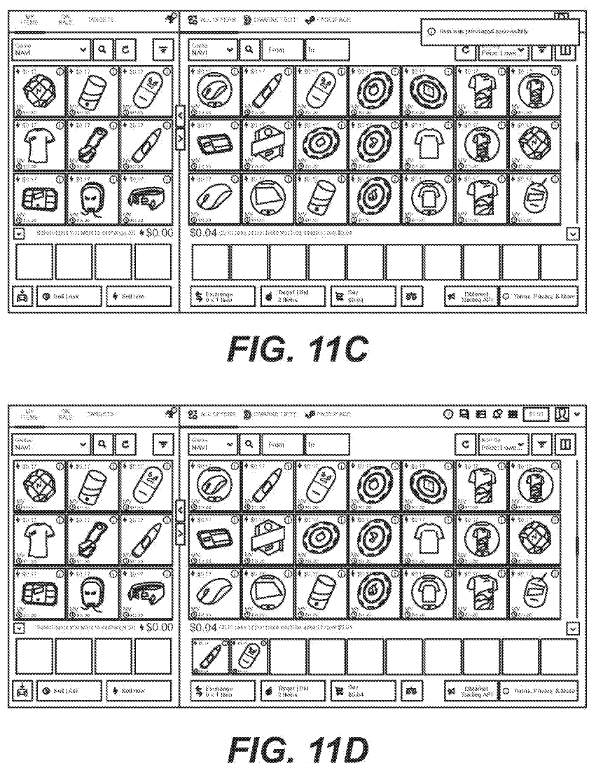

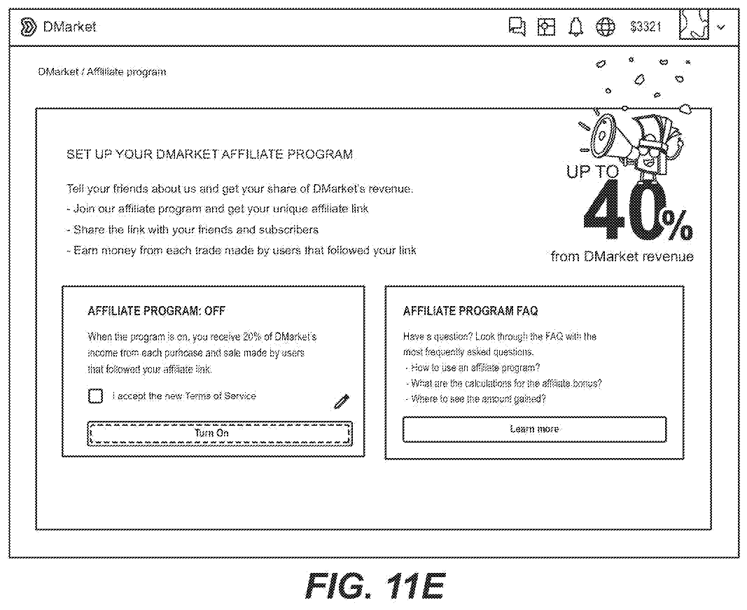

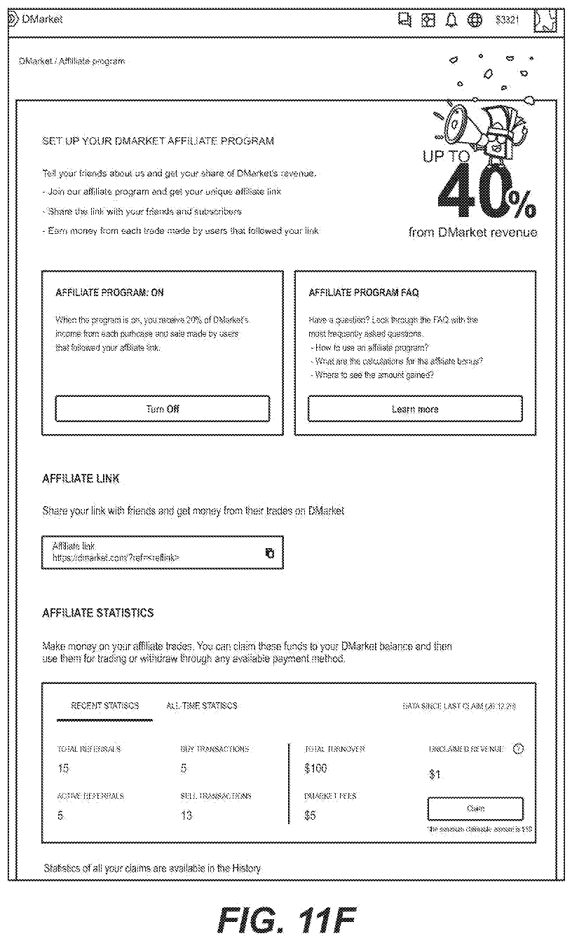

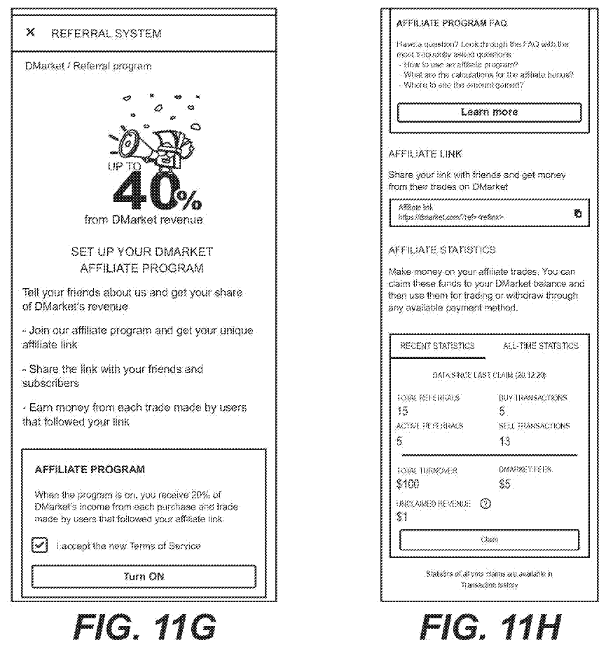

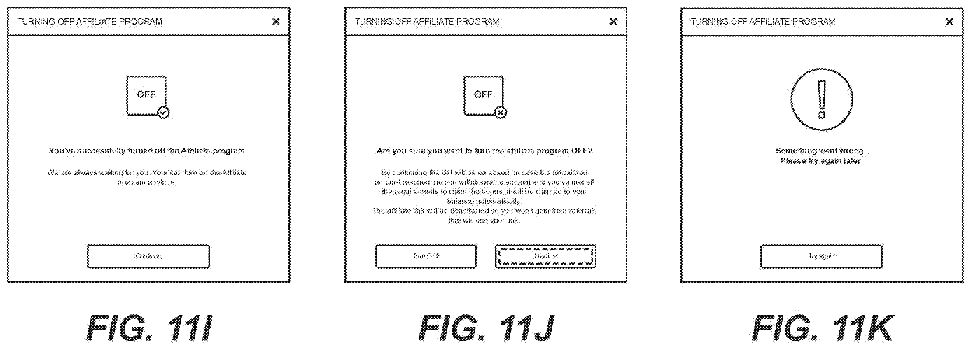

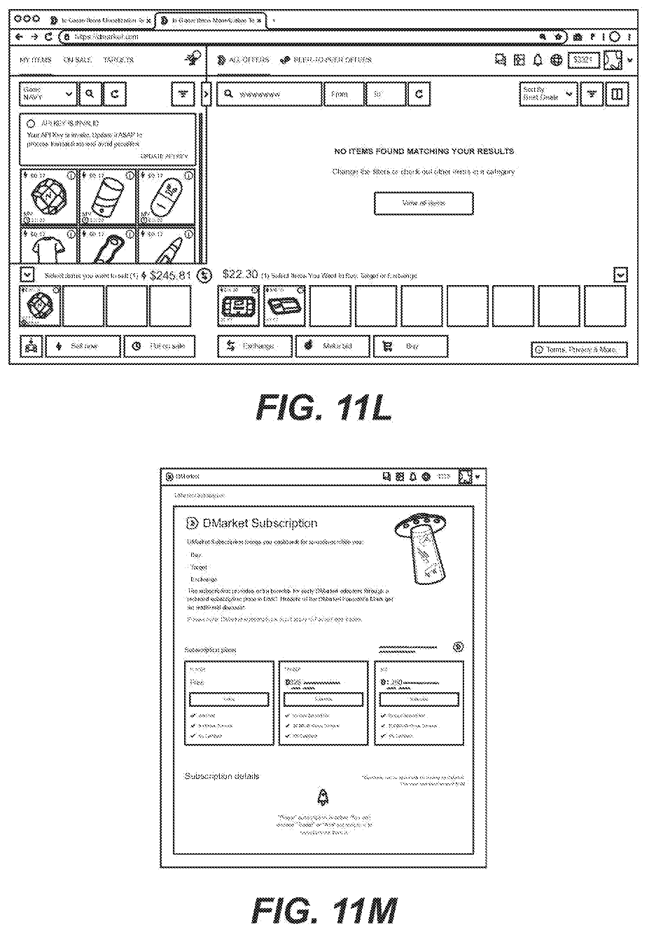

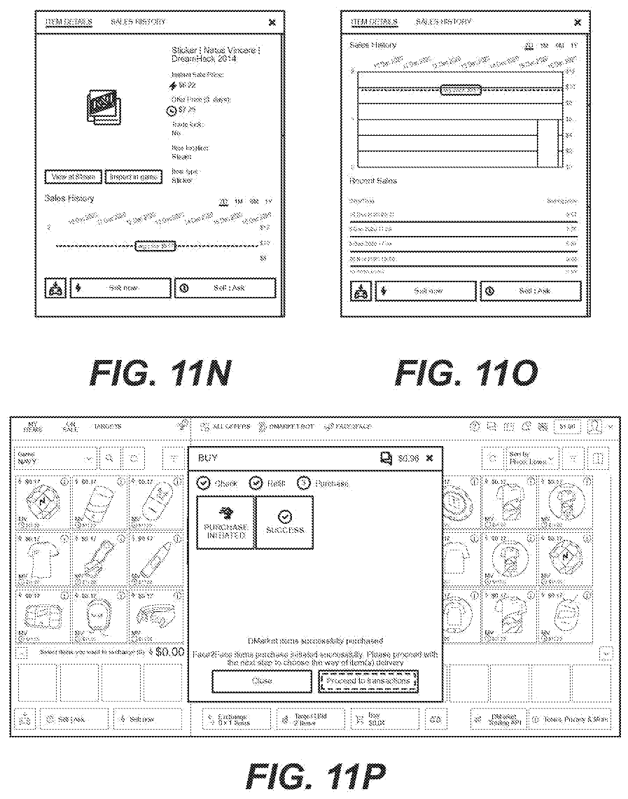

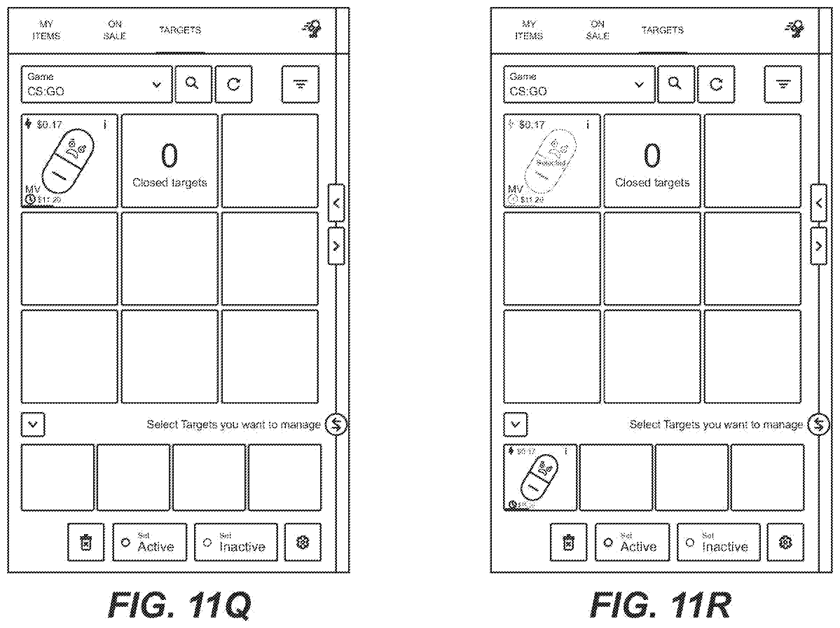

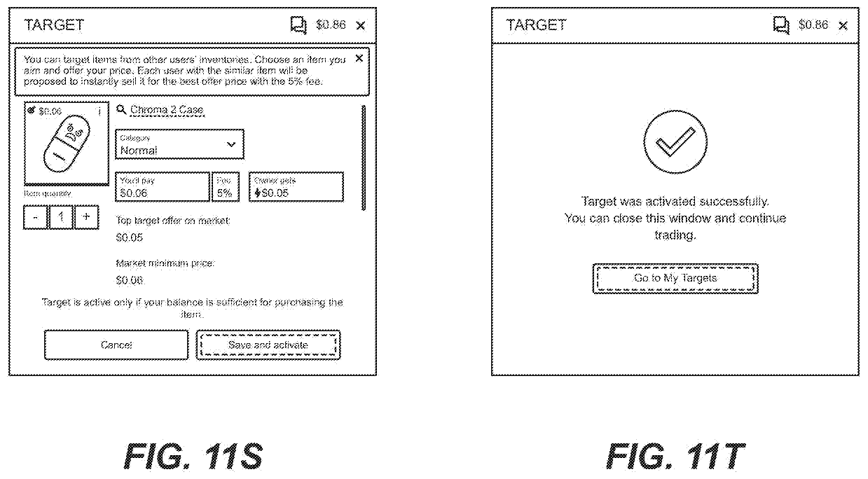

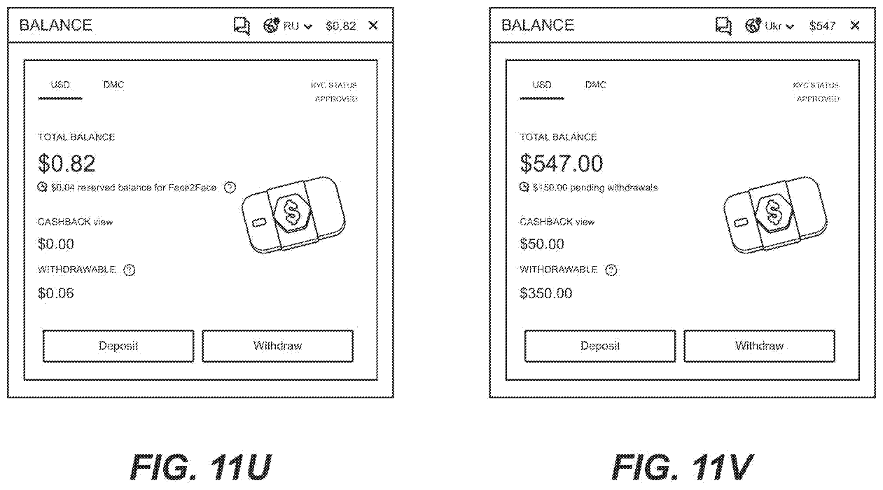

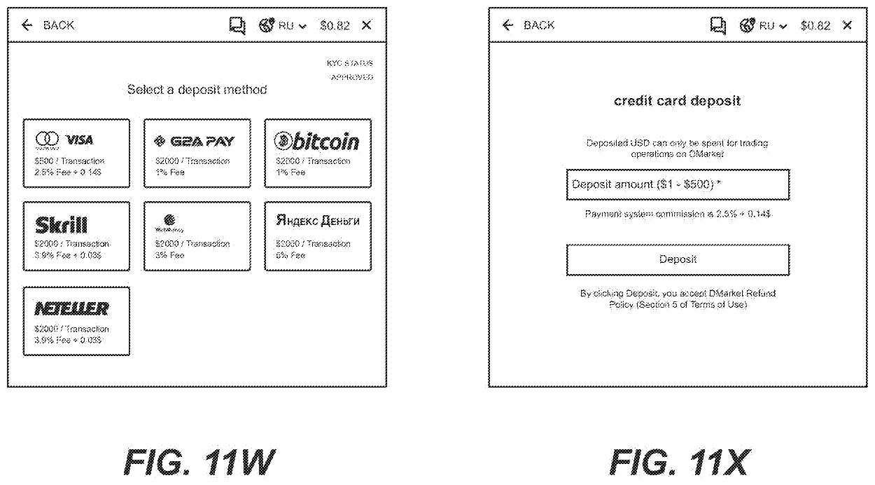

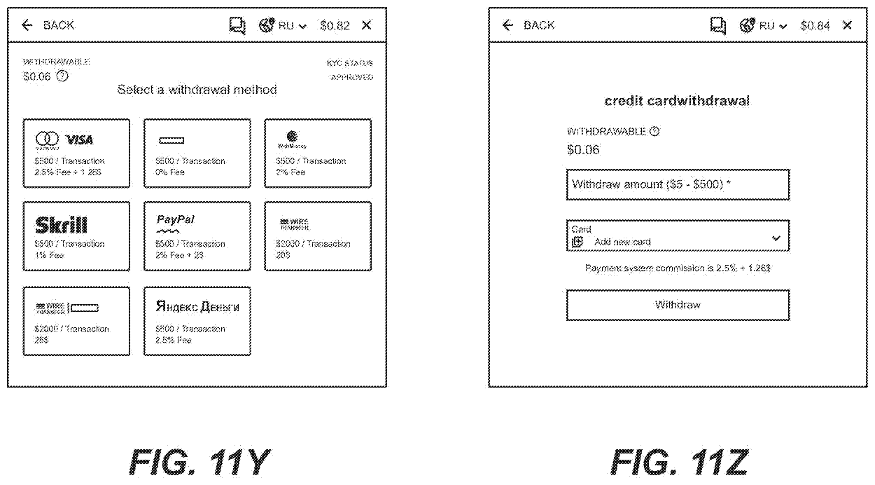

FIGS. 11A-11Z illustrate graphical user interfaces. In one or more embodiments, FIG. 11A depicts an example system.

In one or more embodiments, FIG. 11B depicts how users sign in.

In one or more embodiments, FIGS. 11C-11D depict a general look of a system with all functionality.

In one or more embodiments, FIG. 11E-11K depict affiliate program users can participate in.

In one or more embodiments, FIG. 11L depicts that users can use an applications programming interface (API) to automate trading.

In one or more embodiments, FIG. 11M depicts subscriptions option available for user for cashback options.

In one or more embodiments, FIGS. 11N-11O depict sell mechanics.

In one or more embodiments, FIG. 11P depicts buy mechanics.

In one or more embodiments, FIG. 11Q-11T depict target flows.

In one or more embodiments, FIG. 11U-11Z depicts payment flow.

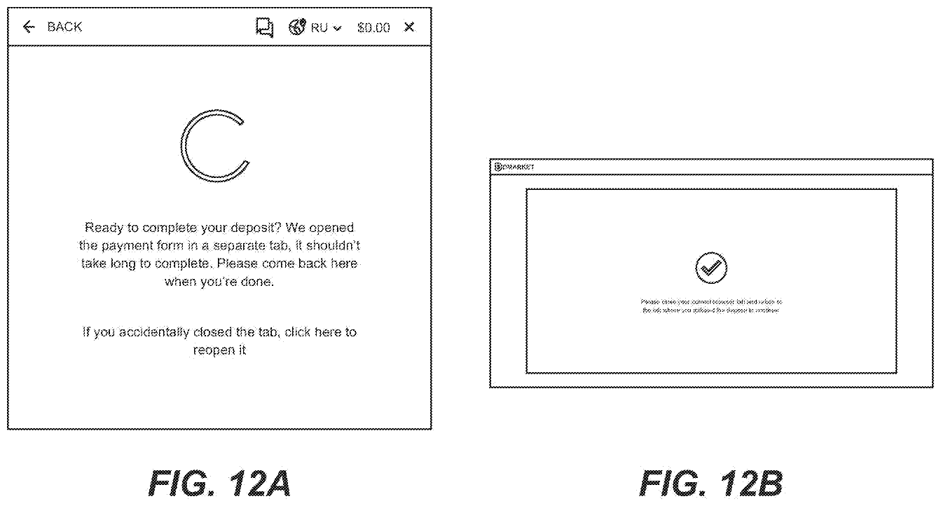

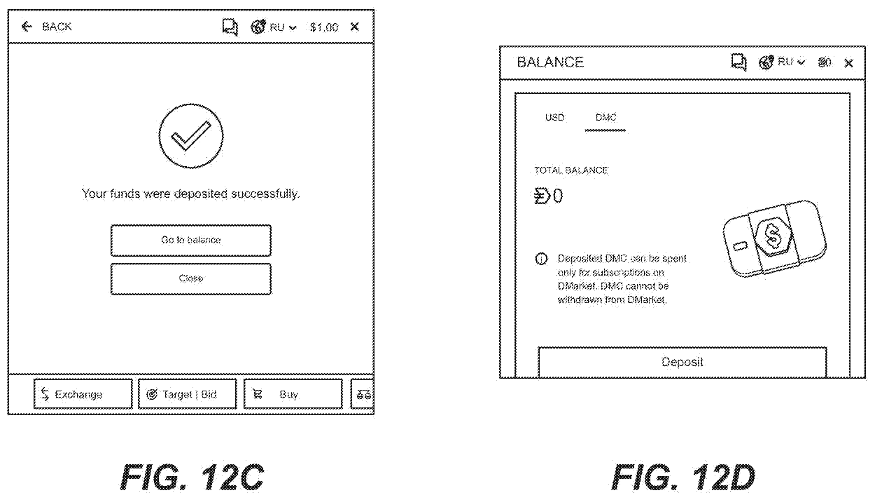

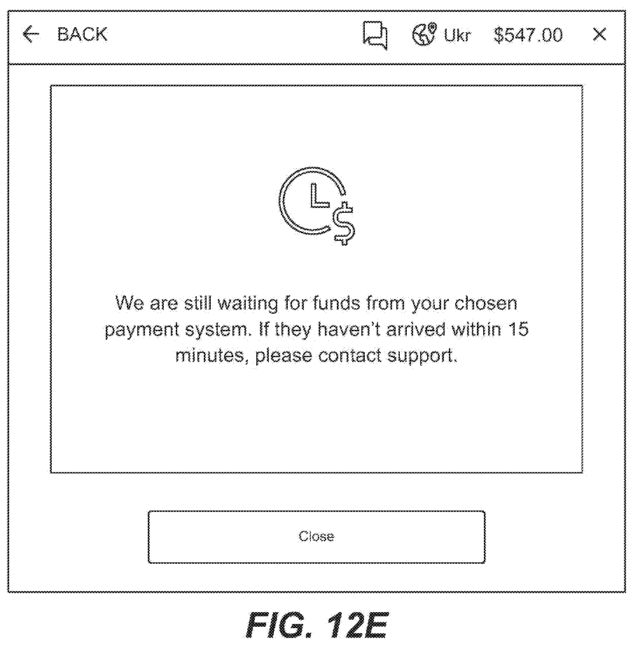

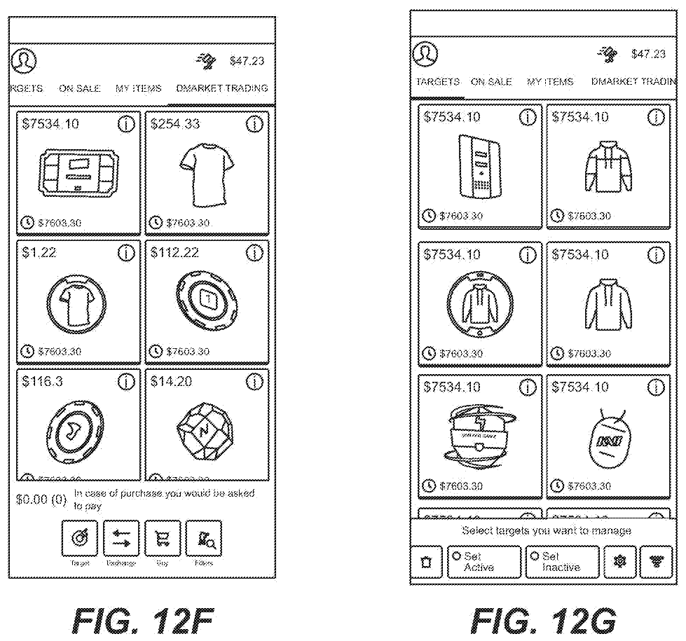

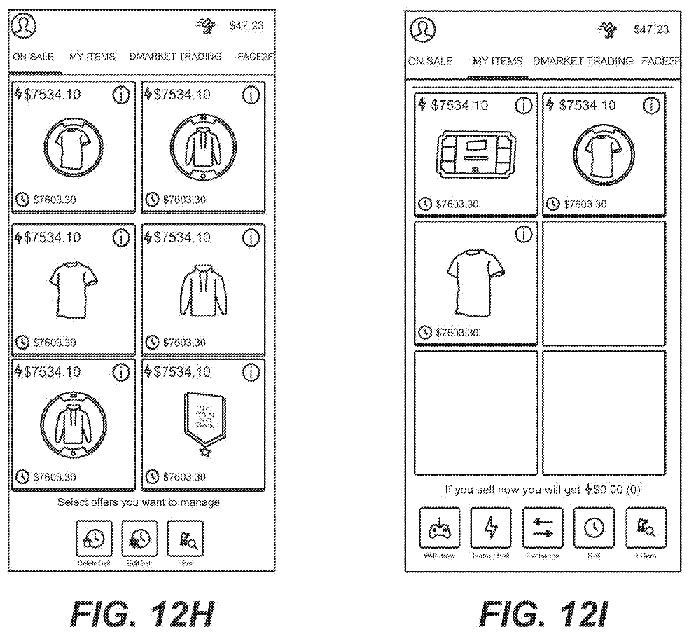

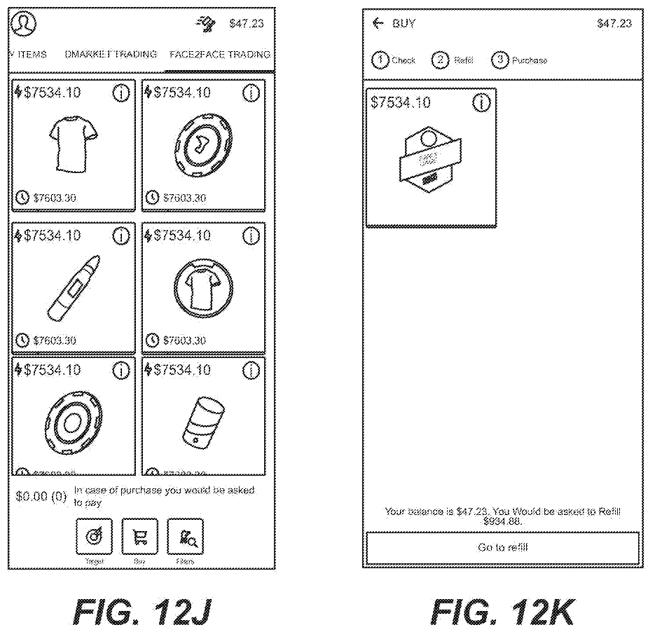

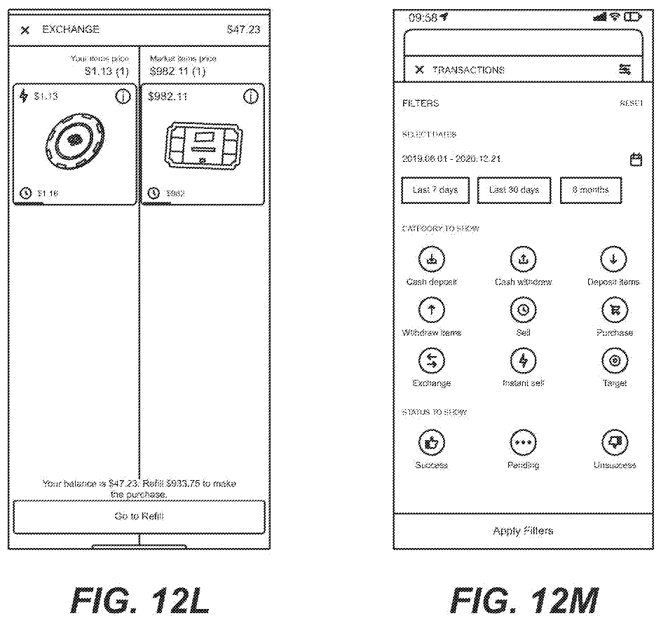

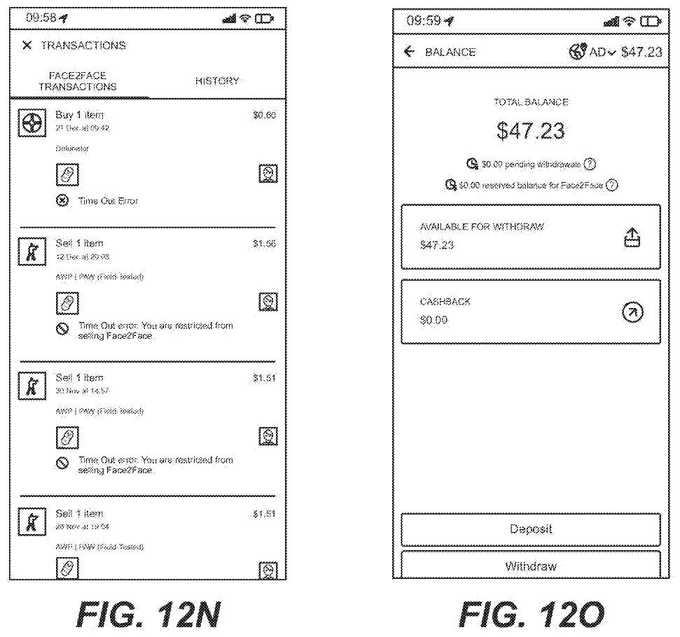

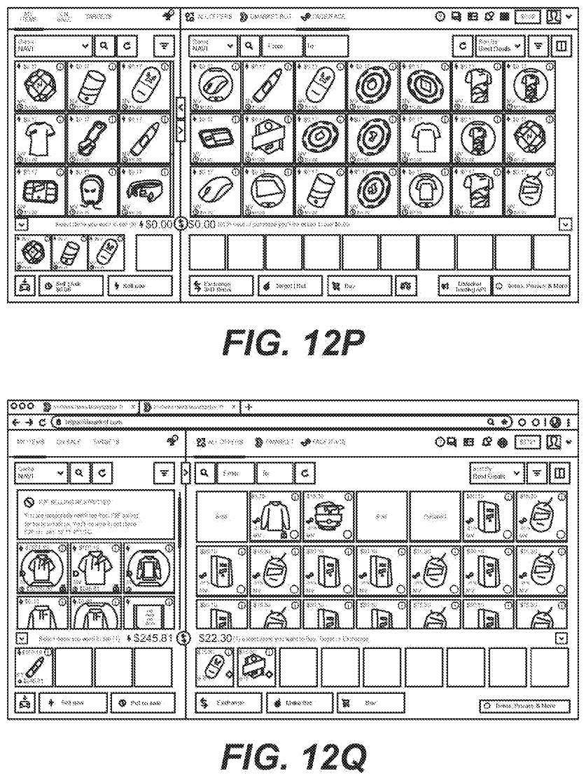

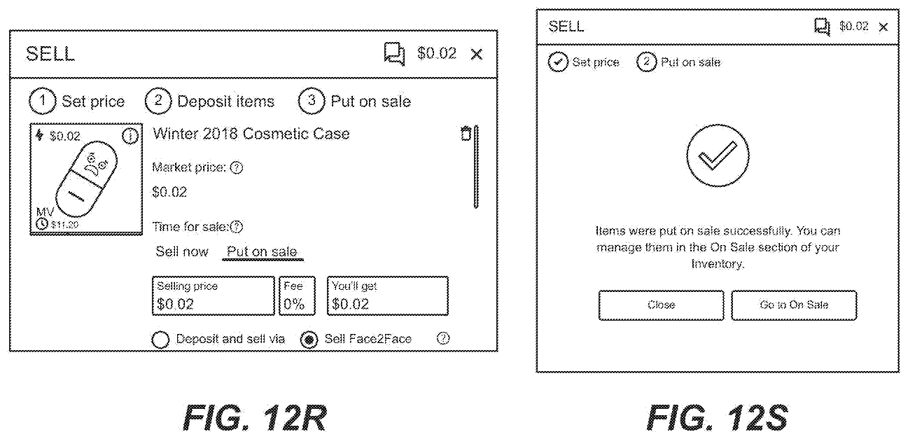

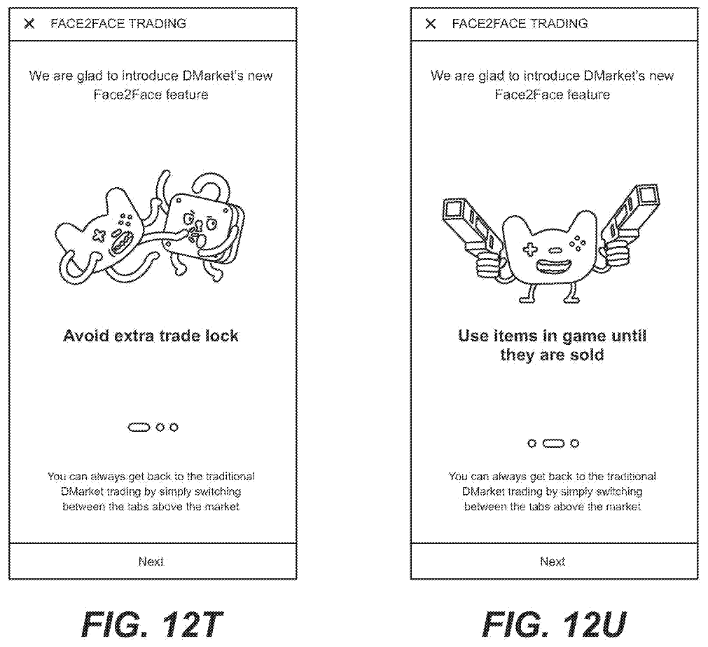

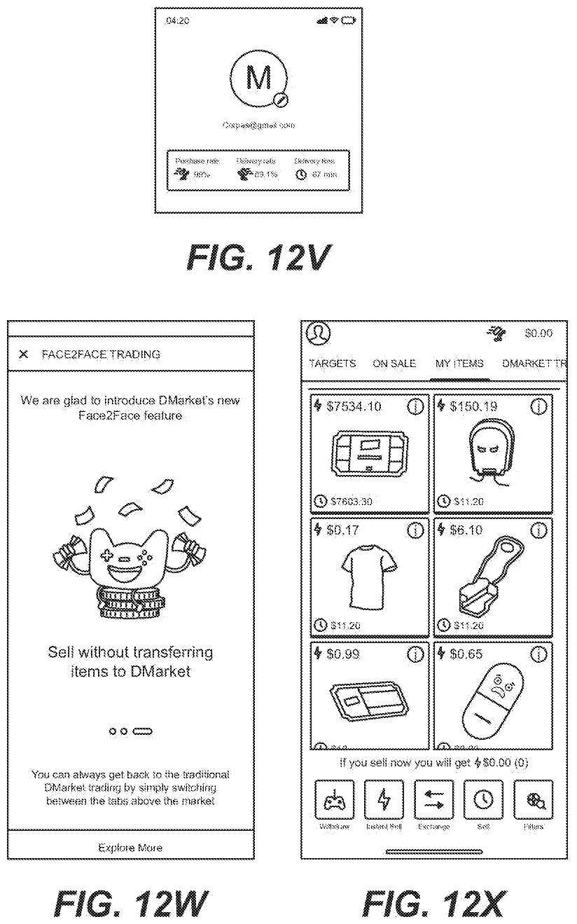

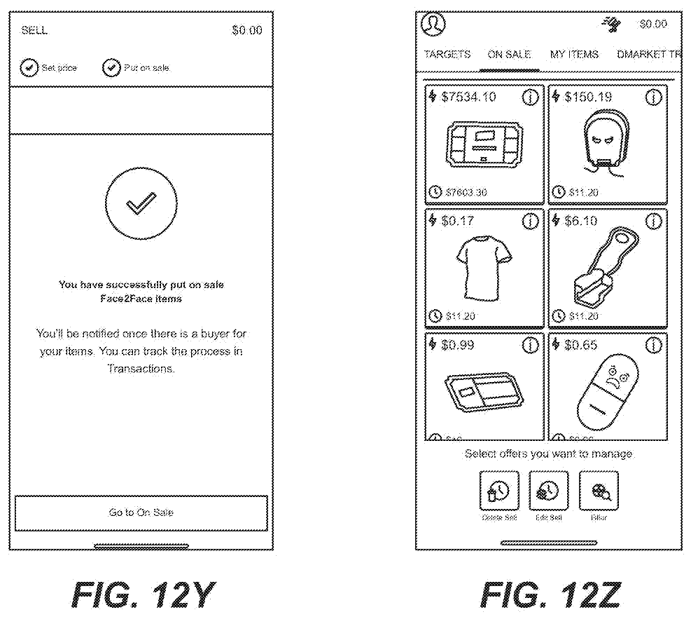

FIGS. 12A-12Z illustrate graphical user interfaces. In one or more embodiments, FIGS. 12A-12O depict mobile application (app) flows.

In one or more embodiments, FIGS. 12P-12Z depict mechanics of Face to Face Sell and Buy flow.

Embodiments of the present disclosure may include a system, a method, and/or a computer program product. The computer program product may include a computer readable storage medium (or media) having computer readable program instructions thereon for causing a processor to carry out aspects of set forth herein.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a hard disk, a random access memory (RAM), a read-only memory (ROM), an erasable programmable read-only memory (EPROM or Flash memory), a static random access memory (SRAM), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the certain embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as Java, the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects set forth herein.

Embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A system for performing a transfer of a non-fungible token (NFT) from a first blockchain to a second blockchain, the system comprising:
a first blockchain module of a first blockchain technology;
a second blockchain module of a second blockchain technology;
an integration module, the integration module configured to store computer executable instructions for communicating with a plurality of blockchain technologies including the first and second blockchain technologies; and
wherein the system is configured for:
disabling the ability of the first blockchain module to act on the NFT;
withdrawing the NFT from the first blockchain module;
locking the NFT on the first blockchain module;
enabling the ability of the second blockchain module to act on the NFT;
depositing the NFT to the second blockchain module;
unlocking the NFT on the second blockchain module; and
recording the transfer of the NFT on the first or second blockchain module.

2. The system of claim 1, further comprising a bridge module, the bridge module configured to communicate with the integration module to receive instructions and communicate with the first and second blockchain modules to send instructions.

3. The system of claim 1, wherein the first blockchain module is part of a video game system and the second blockchain module is a public blockchain that is not part of a video game system.

4. The system of claim 1, further comprising a content provider comprising the first blockchain module, the content provider providing content to a customer, wherein the customer interacts with the content provider to mint the NFT.

5. The system of claim 1, wherein the NFT represents a digital asset on the first blockchain module, and represents a physical asset on the second blockchain module, wherein the transfer of the NFT results in a delivery of the physical asset to a customer.

6. A system for performing a transfer of a non-fungible token (NFT) from a first blockchain to a second blockchain, the system comprising:
a first blockchain module of a first blockchain technology, the first blockchain module comprising a private blockchain;
a second blockchain module of a second blockchain technology, the second blockchain comprising a public blockchain;
a third blockchain module of a third blockchain technology;
an integration module, the integration module configured to store computer executable instructions for communicating with a plurality of blockchain technologies including the first and second blockchain technologies;
bridge module configured to communicate with the integration module to receive instructions and communicate with the first and second blockchain modules to send instructions; and
wherein the system is configured for:
disabling the ability of the first blockchain module to act on the NFT;
withdrawing the NFT from the first blockchain module;
locking the NFT on the first blockchain module;
enabling the ability of the second blockchain module to act on the NFT;
depositing the NFT to the second blockchain module;
unlocking the NFT on the second blockchain module; and
recording the transfer of the NFT on the third blockchain module.

7. The system of claim 6, further comprising a content provider comprising the first blockchain module, the content provider providing content to a customer, wherein the customer interacts with the content provider to mint the NFT.

8. The system of claim 6, wherein the NFT represents a digital asset on the first blockchain module, and represents a physical asset on the second blockchain module, wherein the transfer of the NFT results in a delivery of the physical asset to a customer.

9. The system of claim 7, wherein the NFT represents a digital asset on the first blockchain module, and represents a physical asset on the second blockchain module, wherein the transfer of the NFT results in a delivery of the physical asset to a customer.

10. A method for performing a transfer of a non-fungible token (NFT) from a first blockchain to a second blockchain, the method comprising:
providing a first blockchain module of a first blockchain technology;
providing a second blockchain module of a second blockchain technology;
storing computer executable instructions for communicating with a plurality of blockchain technologies including the first and second blockchain technologies;
disabling the ability of the first blockchain module to act on the NFT;
withdrawing the NFT from the first blockchain module;
locking the NFT on the first blockchain module;
enabling the ability of the second blockchain module to act on the NFT;
depositing the NFT to the second blockchain module;
unlocking the NFT on the second blockchain module; and
recording the transfer of the NFT on the first or second blockchain module.

11. The method of claim 10, further comprising communicating to receive instructions from the first and second blockchain modules to send instructions.

12. The method of claim 10, wherein the first blockchain module is part of a video game system and the second blockchain module is a public blockchain that is not part of a video game system.

13. The method of claim 10, further comprising providing content to a customer, wherein the customer interacts with the content to mint the NFT.

14. The method of claim 10, wherein the NFT represents a digital asset on the first blockchain module, and represents a physical asset on the second blockchain module, wherein the transfer of the NFT results in a delivery of the physical asset to a customer.
